(19) United States
(12) Patent Application Publication
(10) Pub. No.: US 2016/0027025 A1
(43) Pub. Date: Jan. 28, 2016

(54) SYSTEMS AND METHODS OF COUNTING UNIQUE INTERACTIONS BETWEEN USERS OF A SOFTWARE APPLICATION

(71) Applicant: Tune, Inc., Seattle, WA (US)

(72) Inventor: Niek Sanders, Seattle, WA (US)

(21) Appl. No.: 14/810,367

(22) Filed: Jul. 27, 2015

Related U.S. Application Data
(63) Continuation of application No. 14/473,983, filed on Aug. 29, 2014.
(60) Provisional application No. 61/871,755, filed on Aug. 29, 2013.

(51) Int. Cl. G06Q 30/02

(52) U.S. Cl. CPC G06Q 30/0201; G06Q 30/0242

(57) ABSTRACT

Systems and methods are provided for counting unique user interactions within an application. Records of interactions between two or more users are obtained, and hash values that represent the users are calculated based on the records. In some embodiments, a conditional put of the hash value is performed in a database to determine whether a matching hash value has already been recorded. Once it is determined whether a given interaction is a duplicate or a unique interaction, counts of unique interactions or duplicate interactions for the users may be incremented.

### CROSS-REFERENCES TO RELATED APPLICATIONS

This application is a continuation of U.S. application Ser. No. 14/473,983, filed Aug. 29, 2014, which claims the benefit of Provisional Application No. 61/871,755, filed Aug. 29, 2013, the entire disclosures of which are hereby incorporated by reference herein for all purposes.

### BACKGROUND

Many online advertisers compensate third parties (such advertisement publishers, advertising networks, and the like) who present advertisements to visitors of their websites and/or users of their software applications. For example, many advertisers pay such third parties whenever an end user “clicks” on an advertisement and/or “installs” their software application. However, not all users have the same value to advertisers. In particular, if the subject matter of the advertisement is a mobile or web application, it is particularly desirable for the advertiser to know if a user of the application also interacts with other users of the software application, as well as the frequency of those interactions. Users with more interactions are more valuable at least because they may influence other users, and so advertisers may wish to particularly reward third parties for generating clicks and/or installs by these high-value users. What are needed are systems and methods for measuring social interactions by users to determine which users are particularly influential.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of compensating acquisition of influential users is provided. A record of an ad provider attributed with an installation of an application on a client computing device associated with a first user is created. At least one social interaction performed by the first user using the application is detected. A social influence score is determined for the first user based on the detected at least one social interaction, and a credit is assigned to the ad provider for acquisition of the first user, and amount of the credit based on the social influence score for the first user.

In some embodiments, a system is provided that comprises a tracking data store and a tracking server. The tracking data store is configured to store records that associate ad providers with installations of an application on client computing devices, and to store social influence scores for a plurality of users of the application. The tracking server is configured to collect social interaction records, wherein each social interaction record identifies two or more users engaging in a social interaction using the application; determine social influence scores for users of the application based on the collected social interaction records; store the social influence scores in the tracking data store; and assign credit to the ad providers based on the social influence scores.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates an exemplary embodiment of a system configured to track advertisement selections, application installations, and social interactions according to various aspects of the present disclosure;

FIG. 2A is a block diagram that illustrates a first exemplary flow of information through a portion of the system of FIG. 1 according to various aspects of the present disclosure;

FIG. 2B is a block diagram that illustrates a second exemplary flow of information through a portion of the system of FIG. 1 according to various aspects of the present disclosure;

FIG. 2C is a block diagram that illustrates a third exemplary flow of information through a portion of the system of FIG. 1 according to various aspects of the present disclosure;

FIG. 2D is a block diagram that illustrates a fourth exemplary flow of information through a portion of the system of FIG. 1 according to various aspects of the present disclosure;

FIG. 3 is a flowchart that illustrates an exemplary method of creating an advertisement including a tracking link according to various aspects of the present disclosure;

FIG. 4 is a flowchart that illustrates an exemplary method of creating the tracking link according to various aspects of the present disclosure;

FIG. 5 is a flowchart that illustrates an exemplary method of distributing the advertisement including the tracking link according to various aspects of the present disclosure;

FIG. 6A is a flowchart that illustrates an exemplary method of selecting the advertisement and installing an application associated with the advertisement according to various aspects of the present disclosure;

FIG. 6B is a flowchart that illustrates an exemplary method of collecting device information when the advertisement is selected according to various aspects of the present disclosure;

FIG. 7A is a flowchart that illustrates an exemplary method in which an advertisement provider computing device either instructs an end user computing device to open the application associated with the advertisement, or redirects the end user computing device to an application provider from which the application may be downloaded and installed, according to various aspects of the present disclosure;

FIG. 7B is a flowchart that illustrates an exemplary method of recording a user click record according to various aspects of the present disclosure;

FIG. 8 is a flowchart that illustrates an exemplary method of collecting device information when the application associated with the advertisement is installed and matching at least a portion of the device information with the device information collected when the advertisement was selected according to various aspects of the present disclosure;

FIG. 9 is a flowchart that illustrates an exemplary method of sending a tracking identifier (and other information) to a tracking system when an in-application event occurs within the installed application according to various aspects of the present disclosure;

FIG. 10 is a flowchart that illustrates an exemplary method of storing the tracking identifier (and other information) sent to the tracking system when the in application event occurred within the installed application according to various aspects of the present disclosure;

FIG. 11A depicts an exemplary first management interface page configured to request a tracking link and provide the requested tracking link to a customer according to various aspects of the present disclosure;

FIG. 11B depicts an exemplary second management interface page configured to display reports according to various aspects of the present disclosure;

FIG. 12 is a schematic diagram of exemplary hardware and an exemplary operating environment in conjunction with which implementations of the computing devices and network of the system of FIGS. 1 and 2A-2D may be practiced according to various aspects of the present disclosure;

FIG. 13 is a block diagram that illustrates an exemplary embodiment of a tracking system that includes features for determining influence of acquired users and providing appropriate compensation according to various aspects of the present disclosure;

FIGS. 14A-14B are a flowchart that illustrates an exemplary embodiment of a method for determining influence of acquired users of a software application and providing appropriate compensation according to various aspects of the present disclosure;

FIG. 15 is a flowchart that illustrates an exemplary embodiment of a procedure for receiving a notification of a social interaction according to various aspects of the present disclosure;

FIG. 16 is a flowchart that illustrates another exemplary embodiment of a procedure for receiving a notification of a social interaction according to various aspects of the present disclosure; and

FIG. 17 is a flowchart that illustrates an exemplary embodiment of a procedure for determining whether an interaction event has previously been tracked according to various aspects of the present disclosure.

### DETAILED DESCRIPTION

### Tracking System Overview

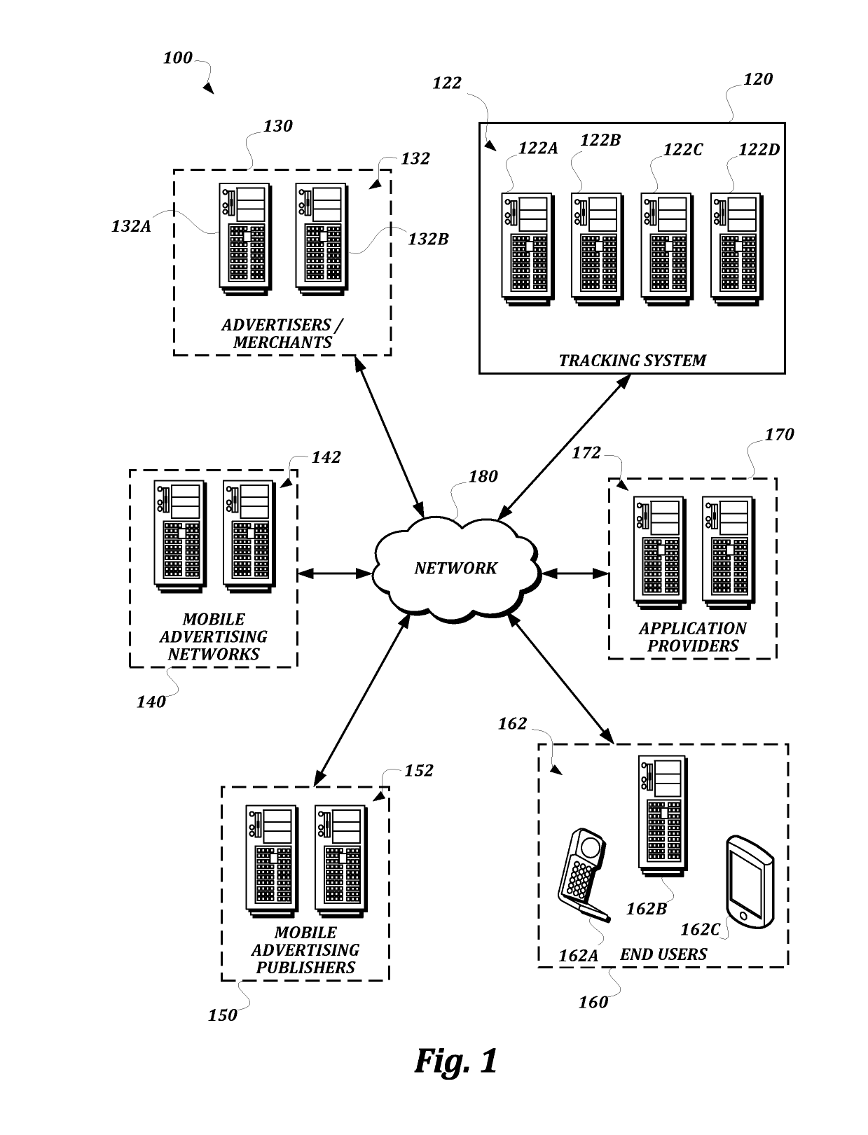

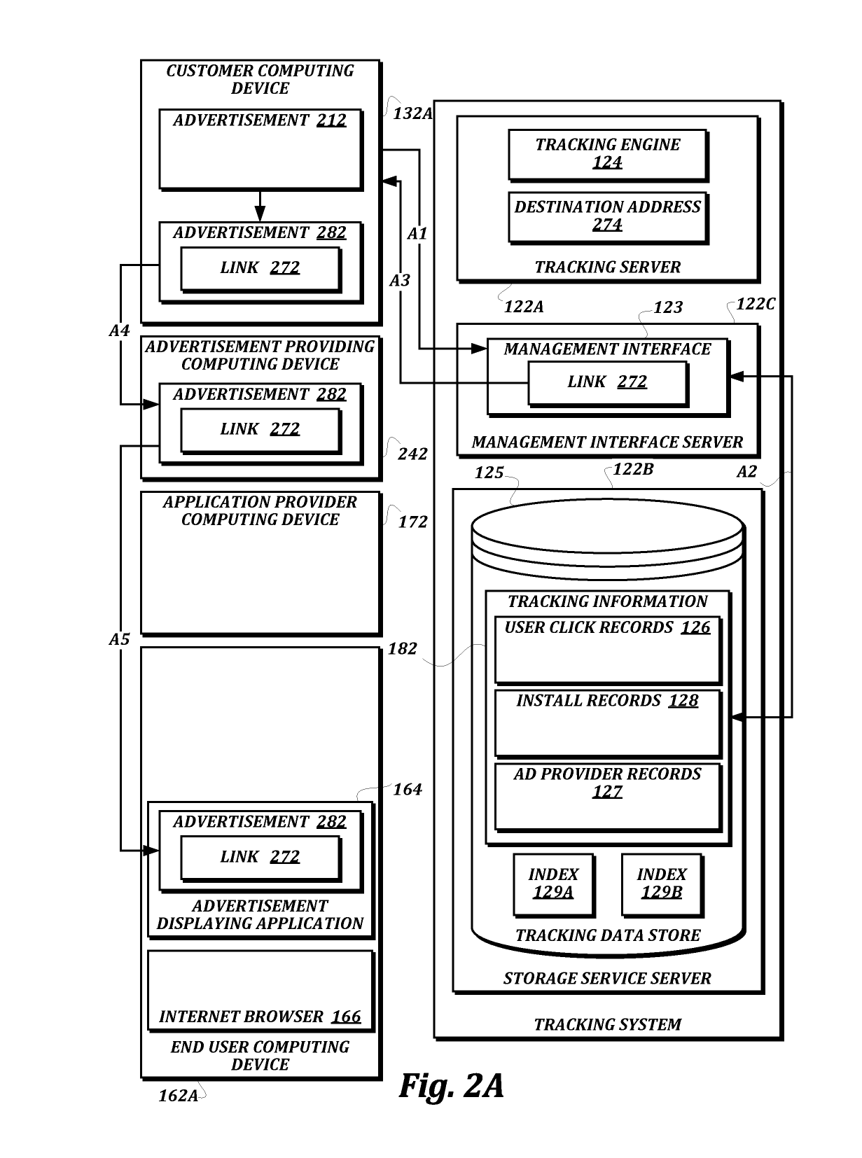

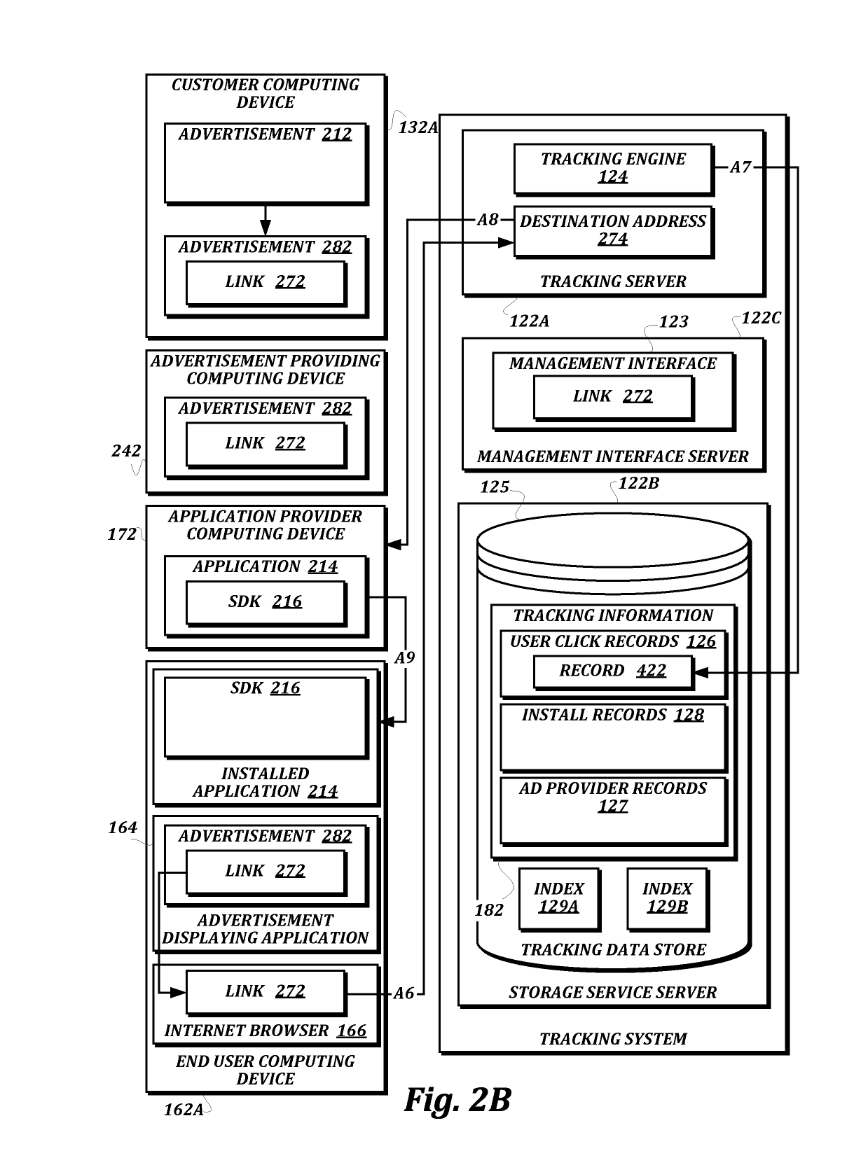

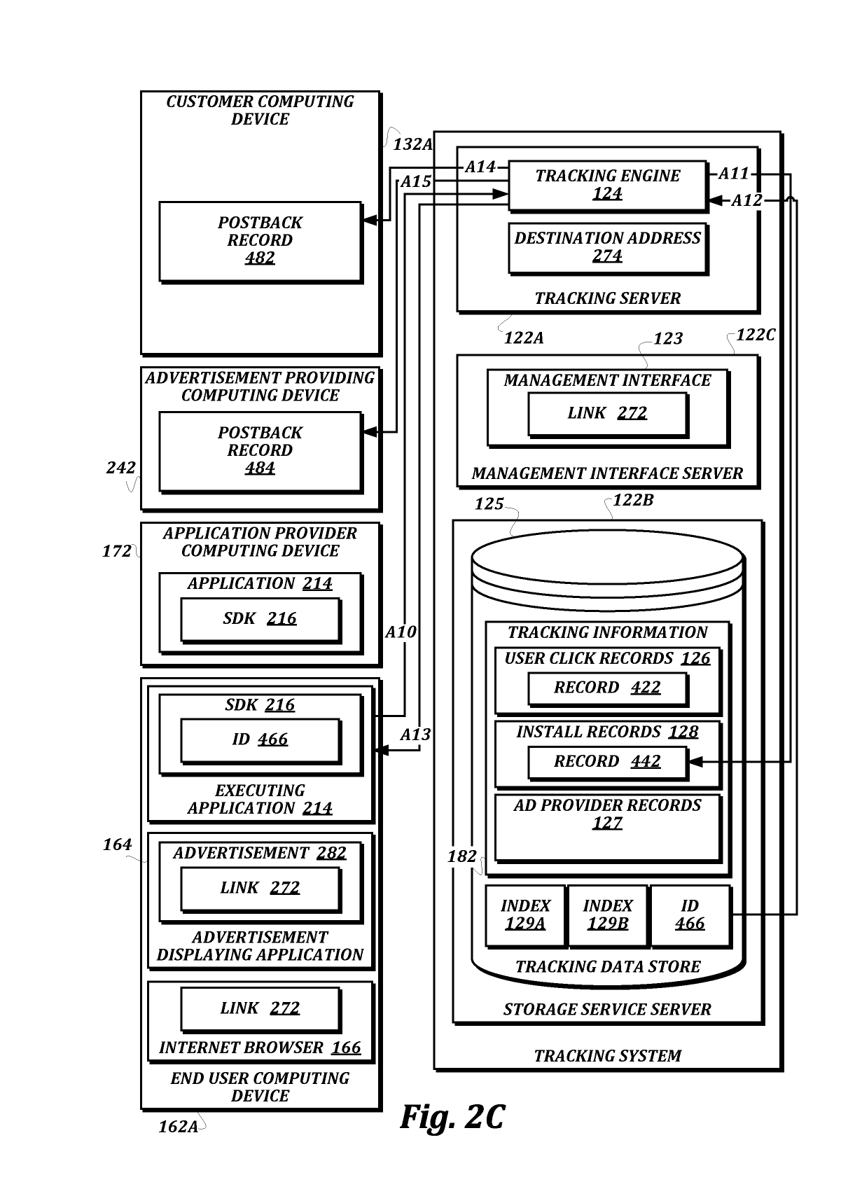

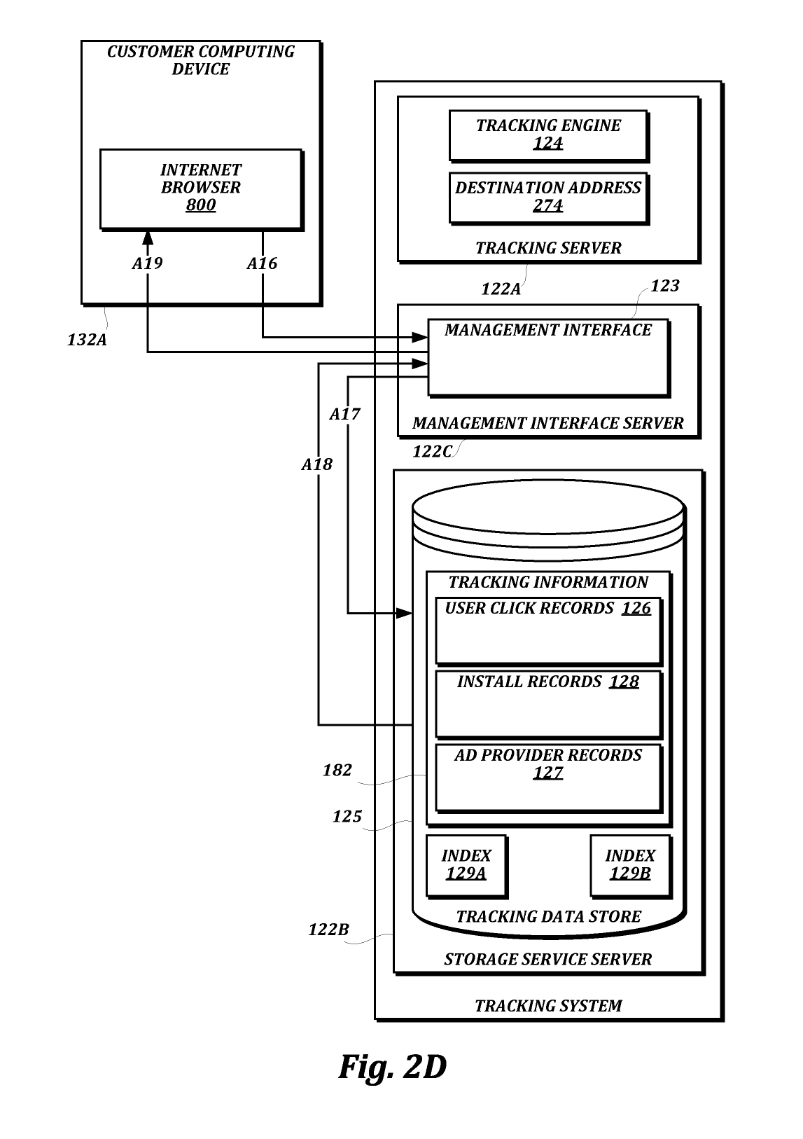

FIG. 1 is a block diagram that illustrates an exemplary embodiment of a system 100 configured to match interactions with (e.g., clicks on) advertisements with subsequent installations and usage of applications associated with the selected advertisements so that such actions may be attributed to the appropriate party or parties that provided (e.g., distributed and/or displayed) the selected advertisements to those who interacted with the advertisements and installed the applications, according to various aspects of the present disclosure. FIGS. 2A-2D are block diagrams that illustrate exemplary embodiments of information flow through portions of the system 100 according to various aspects of the present disclosure.

Turning to FIG. 1, the system 100 includes a tracking system 120. The tracking system 120 includes one or more computing devices 122. In the embodiment illustrated, the computing devices 122 include a tracking server 122A, a storage service server 122B, a management interface server 122C, and a deduplication server 122D. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A, the deduplication server 122D, and/or the management interface server 122C may be combined on a single computing device (not shown). The tracking system 120 is not limited to the use of a particular number of computing devices to implement the functionality of the tracking server 122A, the storage service server 122B, the management interface server 122C, and the deduplication server 122D.

Turning to FIG. 2A, the tracking server 122A is configured to provide a tracking engine 124 that communicates with the storage service server 122B. In general, the term “engine” as used herein refers to logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines or applications, or can be divided into sub-engines. The engines can be stored in any type of computer readable medium or computer storage device and be stored on and executed by one or more general purpose computers, thus creating a special purpose computer configured to provide the engine.

The storage service server 122B is configured to provide a tracking data store 125 that stores tracking information 182 received from the tracking server 122A and/or the management interface server 122C. The tracking information 182 includes a plurality of user click records 126, one or more application installation records 128, and one or more advertisement provider records 127. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

In some embodiments, each of the user click records 126 includes a site ID value (or a package name value) and device information. Similarly, each of the application installation records 128 includes a site ID value (or a package name value) and device information. The site ID value and the package name value each identify the application 214 for which advertising performance is being tracked (see FIG. 2B). The device information includes at least one device identifier and/or other information associated with one of the computing devices 162 (see FIG. 1). The device identifiers may be assigned to the computing devices 162 to uniquely identify the computing devices 162. Examples of device identifiers include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), combinations thereof, and the like. By way of a non-limiting example, the IMEI may be an Android IMEI. By way of another non-limiting example, the MEID may be an Android MEID. The other information associated with one of the computing devices 162 (see FIG. 1) may include an Internet Protocol (“IP”) Address, browser information (e.g., browser type, browser version, etc.), combinations thereof, and the like. The other information may be usable to identify a computing device 162, though the other information may be less reliable for uniquely identifying a computing device 162 than the device identifiers. Optionally, all or a portion of the device information may be hashed instead of being stored directly in plain text in the tracking information 182.

The tracking engine 124 may use the tracking data store 125 to store the user click records 126, the application installation records 128, and/or the advertisement provider records 127. In some embodiments, the tracking data store 125 is configured to create indexes (e.g., indexes 129A and 129B). The index 129A indexes the device information in the user click records 126. The index 129B indexes tracking identifiers (discussed below).

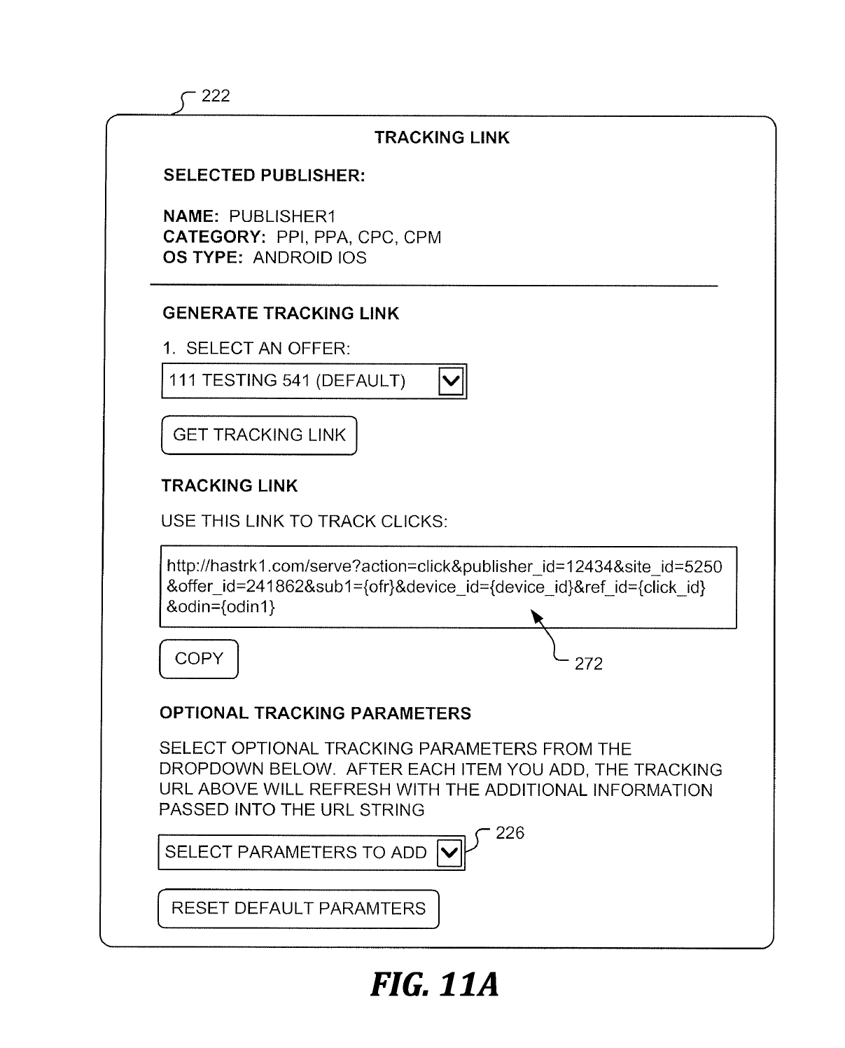

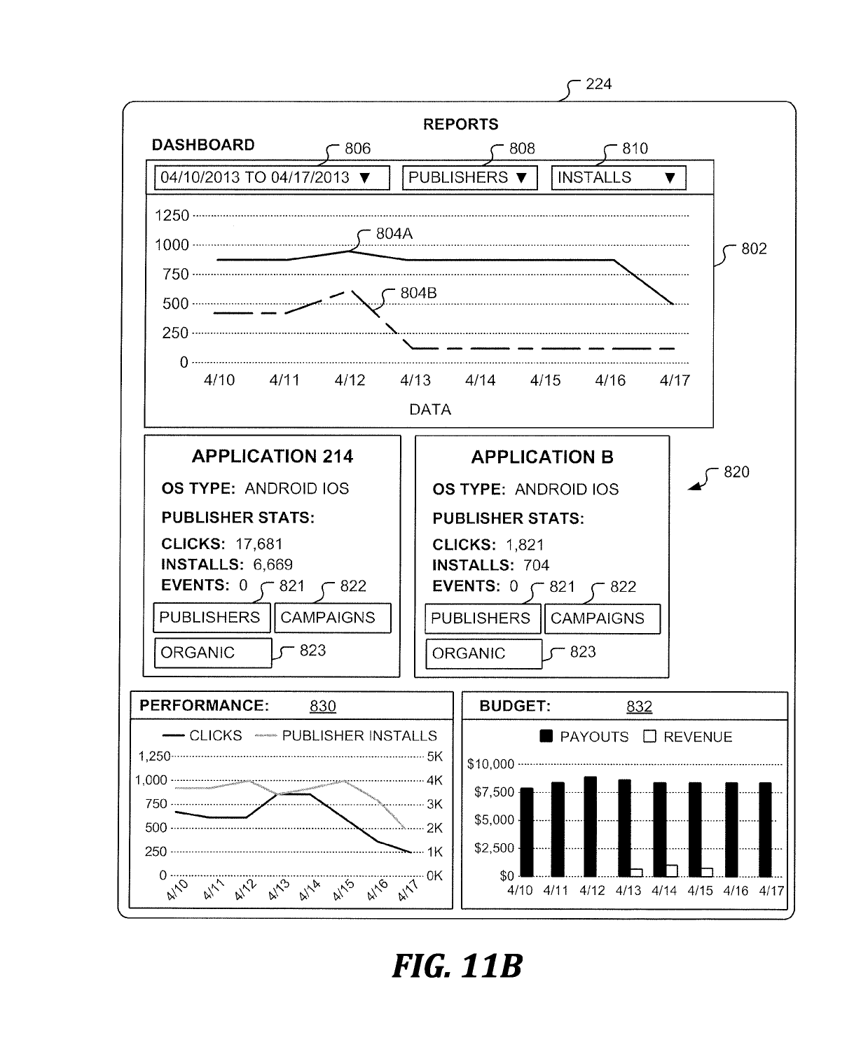

The management interface server 122C includes a management interface engine 123 configured to generate a management interface (e.g., a tracking link page 222 illustrated in FIG. 11A and a reports page 224 illustrated in FIG. 11B), described below. The management interface engine 123 is configured to access (e.g., via an Application Programming Interface (“API”)) the tracking information 182 stored in the tracking data store 125 and use the tracking information 182 to generate displays (e.g., graphs, charts, lists, reports, etc.) for the management interface.

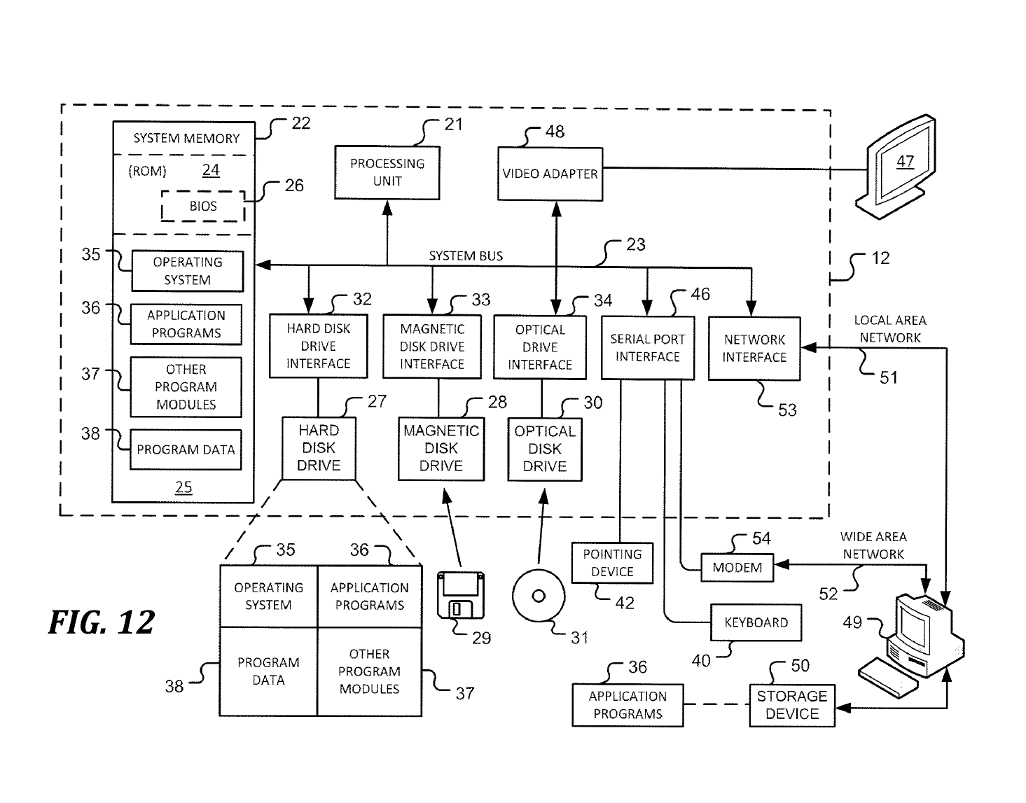

The management interface engine 123 may include or communicate with web server components (not shown) configured to present conventional webpages displayable by conventional Internet browser applications executing on computing devices, such as a computing device 12 illustrated in FIG. 12 and described below. The management interface presented by the management interface engine 123 may include one or more web pages (e.g., the tracking link page 222 illustrated in FIG. 11A and the reports page 224 illustrated in FIG. 11B) that may be transmitted by the web server components (not shown) to other computing devices in the system 100 (see FIG. 1). Such web pages may be displayed by conventional Internet browser applications executing on the recipient computing devices.

Referring to FIG. 1, the system 100 includes one or more computing devices 132 operated by one or more Advertisers/Merchants 130, one or more computing devices 142 operated by one or more Mobile Advertising Networks 140, one or more computing devices 152 operated by one or more Mobile Advertising Publishers 150, a plurality of computing devices 162 operated by a plurality of End Users 160, and one or more computing devices 172 operated by one or more Application Providers 170.

As is apparent to those of ordinary skill in the art, a single entity may function as one of the Advertisers/Merchants 130, one of the Mobile Advertising Networks 140, and one of the Mobile Advertising Publishers 150. Such an entity may operate one or more computing devices (not shown) that perform the functions of the computing devices 132, 142, and 152.

The Advertisers/Merchants 130 include companies that wish to advertise products (e.g., software applications) and/or services. As is apparent to those of ordinary skill in the art, to receive some services, the computing devices 162 may be required to install one or more software applications.

The Mobile Advertising Networks 140 include companies that help distribute advertisements for the Advertisers/Merchants 130 for presentation to end users. The Mobile Advertising Networks 140 may provide services to Mobile Advertising Publishers 150 that allow Mobile Advertising Publishers 150 to present advertisements received from the Mobile Advertising Networks 140 to end users. Non-limiting examples of such companies include Google (the AdWords platform), Apple (the iAd platform), Millennial Media, Tapjoy, InMobi, Advertising.com, AdColony, Jumptap, Nexage, and the like.

The Mobile Advertising Publishers 150 include providers of web sites and mobile applications that display advertisements. Non-limiting examples of such companies include Pandora, Spotify, Facebook, Twitter, Bittorrent.com, The Weather Channel, and any other application or website provider that displays advertisements. In some embodiments, a company may act as both a Mobile Advertising Network 140 and a Mobile Advertising Publisher 150.

The End Users 160 include people who use the computing devices 162 and interact with advertisements, such as those created by the Advertisers/Merchants 130, distributed by the Mobile Advertising Networks 140, and/or displayed by the Mobile Advertising Publishers 150. The End Users 160 also use the computing devices 162 to purchase, download, install, and/or interact with applications provided by the Application Providers 170.

The Application Providers 170 include companies that provide installable applications (such as those advertised by the Advertisers/Merchants 130) to the End Users 160. Non-limiting examples of such companies include “app stores,” such as iTunes App Store, Google Play, Amazon Appstore, and the like. The one or more computing devices 172 may be configured to generate a download page (not shown) from which an application may be purchased, downloaded, and/or installed. The download page may be implemented as a webpage.

The computing devices 122, 132, 142, 152, 162, and 172 are connected to one another by a network 180 (e.g., the Internet). Each of the computing devices 122, 132, 142, 152, 162, and 172 may be implemented using a computing device similar to the computing device 12 illustrated in FIG. 12 and described below. By way of non-limiting examples, the computing devices 162 have been illustrated as including a cellular telephone 162A, a personal computer 162B (e.g., a desktop computer), and a tablet computer 162C. Each of the computing devices 162 is configured to implement an advertisement displaying application 164 (see FIGS. 2A-2C), such as an Internet browser application 166 (see FIGS. 2A-2C), and/or a different application configured to display advertisements. In some embodiments (such as the exemplary embodiment illustrated in FIGS. 2A-2C), the advertisement displaying application 164 is depicted as being different from the Internet browser application 166. However, this is not a requirement. In some embodiments, the advertisement displaying application 164 is the Internet browser application 166.

### Tracking Advertising Interactions and Application Installs

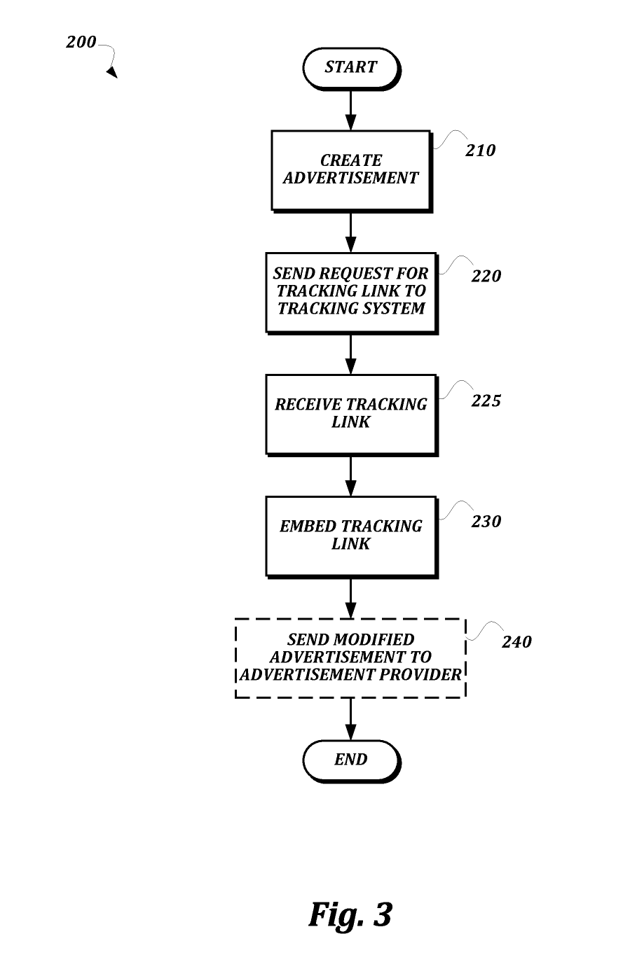

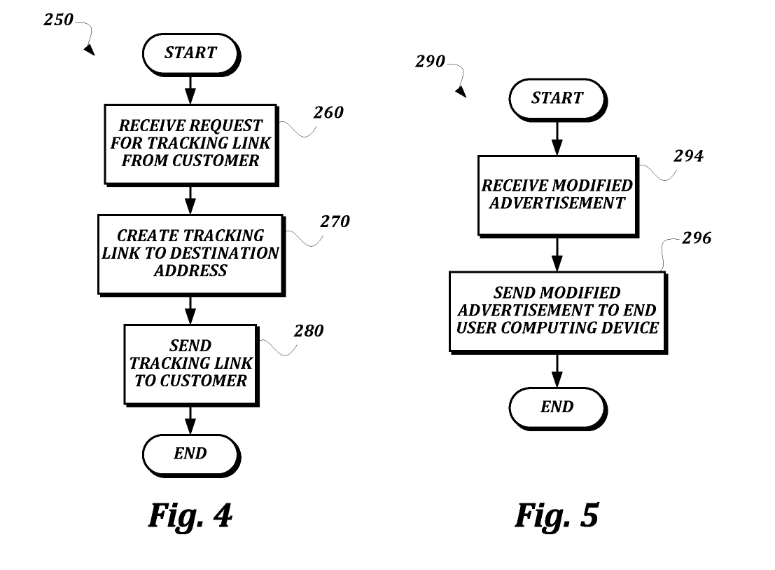

FIGS. 3 and 4 are flowcharts that illustrate exemplary embodiments of methods 200 and 250, respectively. The method 200 is performed by one or more computing devices operated by a customer. Referring to FIG. 1, the customer may be one or more of the Advertisers/Merchants 130, the Mobile Advertising Networks 140, and the Mobile Advertising Publishers 150. Thus, the method 200 may be performed by one or more of the computing devices 132, 142, and/or 152. For ease of illustration, the method 200 will be described as being performed by the computing device 132A operated by one of the Advertisers/Merchants 130, who in this example, is referred to as the customer.

Turning to FIG. 4, the method 250 is performed by the tracking system 120 (see FIG. 1). For ease of illustration, the method 250 will be described as being performed by the management interface engine 123 (see FIG. 2A).

Turning to FIG. 3, from a start block, the method 200 proceeds to block 210, where the customer creates an advertisement 212 (see FIG. 2A) for display to one or more of the End Users 160 by one or more of the plurality of computing devices 162. Turning to FIG. 2A, the advertisement 212 is configured to be displayed by the advertisement displaying application 164 (e.g., the Internet browser application 166 or the separate advertisement displaying application 164) executing on one or more of the plurality of computing devices 162 (e.g., the computing device 162A). The advertisement 212 is associated with an installable application 214 (see FIG. 2B) available for download on one of the computing devices 172 (see FIG. 2B).

In the embodiment illustrated in FIG. 2B, the application 214 includes a tracking Software Development Kit (“SDK”) 216 that includes functions and/or procedures that execute when selected events occur on the computing device (e.g., the computing device 162A) on which the application 214 is installed. For example, the tracking SDK 216 may include computer-executable instructions that execute when the application 214 is installed and used for the first time. By way of a non-limiting example, the tracking SDK 216 may be implemented as a library file that is included in an application project used to create the application 214. An application developer may specify which particular functions are called from the library to indicate to the tracking engine 124 when install events and/or other in-application (“in-app”) events have occurred. The tracking SDK 216 may include a package name value that identifies the application 214.

While the tracking SDK functionality is primarily described herein as an SDK (that is, code provided by the tracking system 120 for incorporation into the application 214) for ease of discussion, in some embodiments the functionality described herein as being provided by the tracking SDK 216 is not implemented by a library file included in an application project used to create the application 214, but is instead accessed by virtue of the application 214 performing remote function calls to an application programming interface (API) provided by the tracking engine 124 or other element of the tracking system 120.

Returning to FIG. 2A, the advertisement 212 is accessible by the customer computing device 132A. In FIG. 2A, the advertisement 212 is stored on the customer computing device 132A. However, this is not a requirement.

Returning to FIG. 3, at block 220, the computing device 132A sends a request for a tracking link 272 to the management interface engine 123 via the network 180. In FIG. 2A, this is illustrated by arrow “A1.” By way of a non-limiting example, the management interface may include the tracking link page 222 (see FIG. 11A) into which the customer enters information and requests the tracking link 272. When the customer submits the tracking link page 222, the request is submitted to the management interface engine 123.

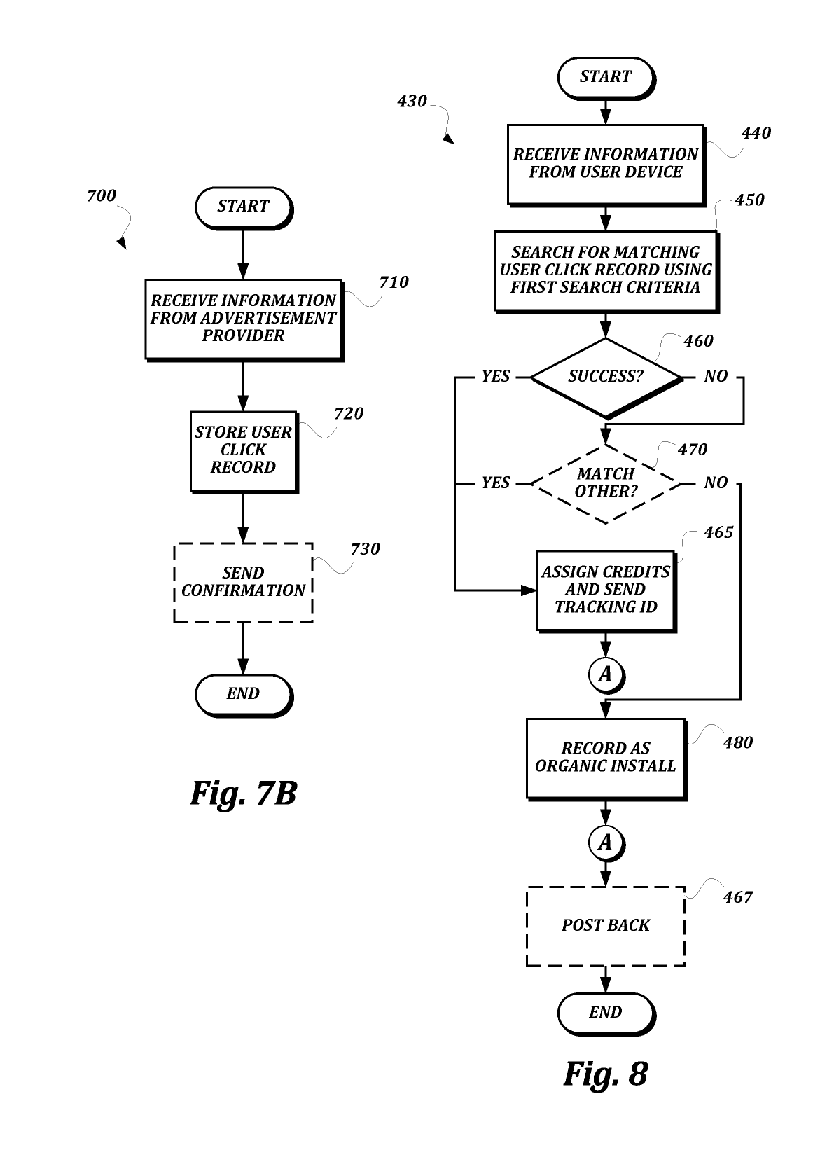

Turning to FIG. 4, at block 260 of the method 250 the management interface engine 123 receives the request for the tracking link 272 from the customer. At block 270, the management interface engine 123 creates the tracking link 272 to a destination address 274. In the embodiment illustrated in FIG. 2B, the destination address 274 is an address on the tracking server 122A. In embodiments in which methods 600 and 700 (see FIGS. 7A and 7B) are performed, the destination address 274 is an address on an advertisement providing computing device 242 (described below). The management interface engine 123 may store information (e.g., a campaign ID value (or an offer ID value), a publisher ID value, a site ID value, and/or the like) in the tracking data store 125. Further, the management interface engine 123 may use the information (e.g., the campaign ID value (or the offer ID value), the publisher ID value, the site ID value, and/or the like) stored in the tracking data store 125 to create the tracking link 272 in block 270. The transfer of information between the management interface engine 123 and the tracking data store 125 is illustrated by double-headed arrow “A2.”

In some embodiments, the campaign ID value or the offer ID value identifies an advertising campaign, and may be used to track the effectiveness of a particular campaign. In some embodiments, the publisher ID value identifies an advertisement provider (e.g., one or more of the Advertisers/Merchants 130, the Mobile Advertising Networks 140, and/or the Mobile Advertising Publishers 150) that operates the advertisement providing computing device 242 (see FIG. 2A). The advertisement provider is described in more detail below.

The tracking link 272 may be implemented as a uniform resource locator (“URL”). The customer can request that the tracking link 272 contain various pieces of information, such as a redirect link, one or more macros (e.g., macros that obtain device information (such as the MAC Address, Android ID, IFA, and/or the like), and/or other pieces of information e.g., the publisher ID, campaign ID, etc.). The destination address 274 and/or the tracking link 272 may be associated with an indicia, such as the site ID and/or the campaign ID. Any or all of these values may be hashed and the hash value included in the tracking link 272 instead of the values themselves.

As mentioned above, the tracking link 272 may include the redirect link. The redirect link may be implemented as an HTTP redirect that sends the end user computing device 162A to a third-party web page or an application provider web site (e.g., an app store) to obtain the application 214. The tracking link 272 may include the indicia and/or the address to which to redirect the computing devices 162. The tracking data store 125 may associate the tracking link 272 with information provided by the customer so the customer may use the tracking information to generate reports using the management interface (e.g., the reports page 224 illustrated in FIG. 11B) generated by the management interface engine 123. For example, the customer may have entered a publisher payout amount that may be used to generate a report that shows publisher payout amounts as compared to revenue earned.

The tracking link page 222 (FIG. 11A) illustrates an example of the tracking link 272. In this example, the tracking link 272 is:
“http://hastrk1.com/serve?action=click&publisher id=12434&site_id=5250&offer_id=241862&sub1={ofr}&device_id={device_id}&ref_id={click_id} &odin={odin1}”

In this link, the destination address 274 (see FIG. 2B) is “http://hastrk1.com/serve.” The publisher ID is set equal to the value “12434,” which identifies the advertisement provider (e.g., one of the Mobile Advertising Publishers 150). The site ID is set equal to the value “5250,” which identifies the application 214. The offer ID is set equal to the value “241862,” which identifies the advertising campaign. Thus, the information stored in the tracking link 272 associates the advertisement with the advertisement provider (e.g., one of the Mobile Advertising Publishers 150), the application 214, and the advertising campaign.

As shown in FIG. 11A, the customer may include additional information in the tracking link 272 by using a user input 226 (e.g., a dropdown box) to select additional parameters. When a parameter is selected using the user input 226, the tracking link 272 is automatically modified to include the parameter and, if appropriate, a value assigned to the parameter.

In embodiments in which the methods 600 and 700 (see FIGS. 7A and 7B, respectively) are performed, the destination address 274 is to an address on the advertisement providing computing device 242. In such embodiments, the redirect address may be omitted.

In block 280, the management interface engine 123 sends the tracking link 272 to the customer computing device 132A via the network 180. In FIG. 2A, this is illustrated by arrow “A3.” By way of a non-limiting example, the management interface engine 123 may include the tracking link 272 in the tracking link page 222 illustrated in FIG. 11A, which may be displayed in a conventional Internet browser and from which the tracking link 272 can be copied and pasted (e.g., into the advertisement 212) by the customer. Then, the method 250 terminates.

Returning to FIG. 3, in block 225, the customer computing device 132A receives the tracking link 272. Optionally, referring to FIG. 2A, the customer may modify the tracking link 272 to include one or more macros that execute after one of the End Users 160 has interacted with (e.g. clicked) the advertisement 214. The macros may cause the end user computing device 162A to dynamically replace the macros with the device information (e.g., at least one device identifier and/or other information) associated with the end user computing device 162A. Further, the tracking link 272 may be modified to include other data, such as identifiers associated with the customer and/or other parties involved with distributing (e.g., one of the Mobile Advertising Networks 140) or displaying (e.g., one of the Mobile Advertising Publishers 150) the advertisement 212 to one of the End Users 160.

In block 230 shown in FIG. 3, referring to FIG. 2A, the customer computing device 132A embeds the tracking link 272 in the advertisement 212 to create a modified advertisement 282. At this point, the modified advertisement 282 is ready to be sent (e.g., pushed) to one or more of the end user computing devices 162.

In optional block 240 shown in FIG. 3, referring to FIG. 2A, the customer computing device 132A sends the modified advertisement 282 to the advertisement providing computing device 242 via the network 180. In FIG. 2A, this is illustrated by arrow “A4.” The advertisement providing computing device 242 is operated by the advertisement provider, which may include one or more of the Advertisers/Merchants 130, the Mobile Advertising Networks 140, and/or the Mobile Advertising Publishers 150. Thus, the advertisement providing computing device 242 may be one or more of the computing devices 132, 142, and/or 152. The advertisement provider may be the same as or different from the customer. In embodiments in which the advertisement provider is the same as the customer, optional block 240 may be omitted.

Then, the method 200 proceeds to an end block and terminates.

FIG. 5 is a flow diagram of a method 290 performed by the advertisement providing computing device 242 (see FIG. 2A) operated by the advertisement provider, which (as mentioned above) may include one or more of the Advertisers/Merchants 130, the Mobile Advertising Networks 140, and/or the Mobile Advertising Publishers 150.

In block 294, the advertisement providing computing device 242 receives the modified advertisement 282 from the customer computing device 132A. In embodiments in which the advertisement provider is the same as the customer, block 294 may be omitted.

Then, in block 296, the advertisement providing computing device 242 (e.g., one of the computing devices 152) sends (e.g., pushes) the modified advertisement 282 to one or more of the plurality of computing devices 162 via the network 180. For ease of illustration, in FIG. 2A, the modified advertisement 282 is pushed to the end user computing device 162A, as illustrated by arrow “A5.” Then, the method 290 terminates.

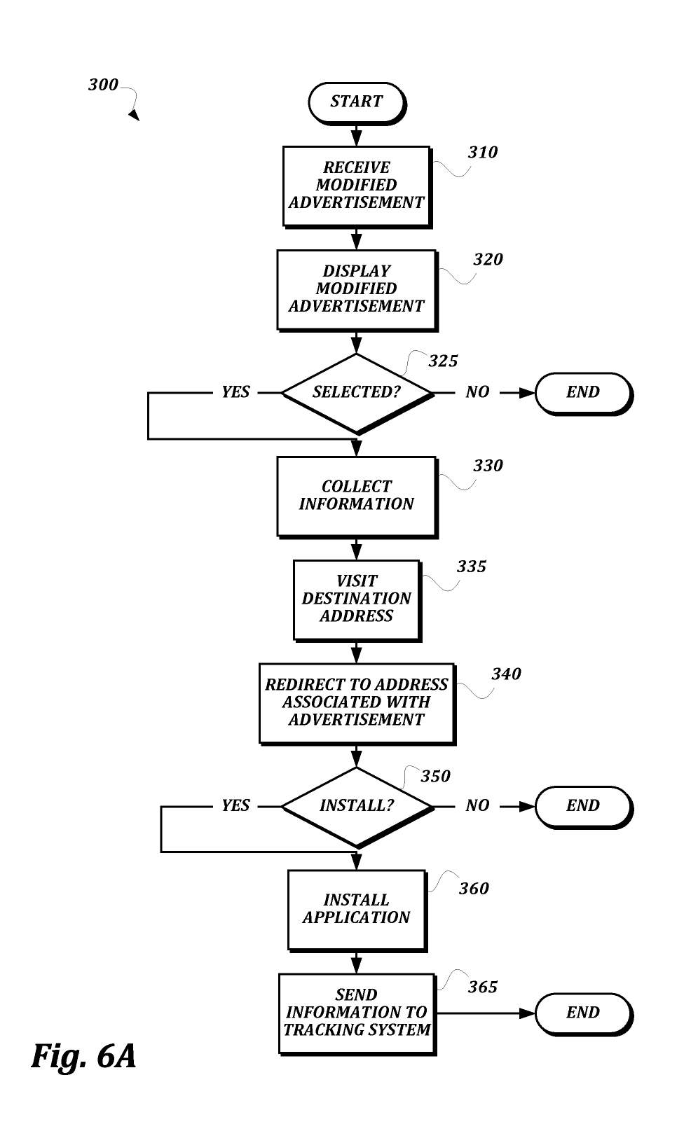

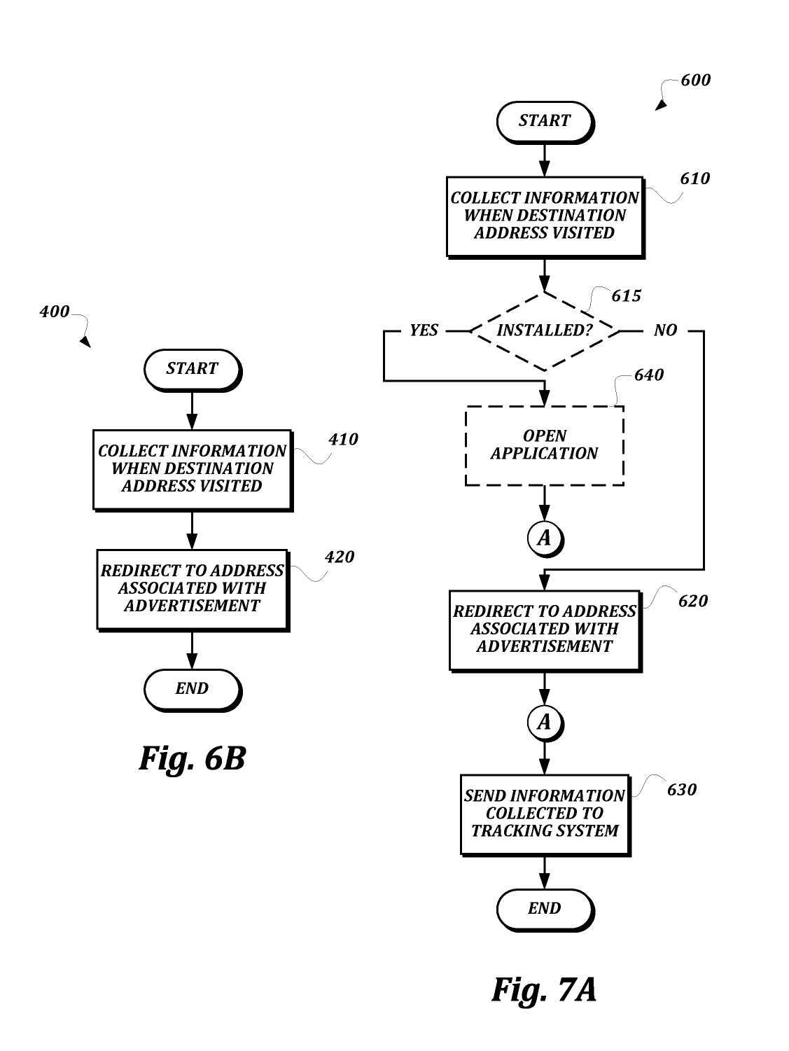

FIGS. 6A and 6B are flow diagrams of methods 300 and 400, respectively. The method 300 is performed by one of the computing devices 162 operated by the end Users 160. Thus, the method 300 may be performed by one or more of the computing devices 162A, 162B, or 162C. For ease of illustration, the method 300 will be described as being performed by the end user computing device 162A. The method 400 is performed by the tracking system 120. For ease of discussion, the method 400 will be described as being performed by the tracking engine 124 executing on the tracking server 122A. However, as is apparent to those of ordinary skill in the art, portions of the method 400 may be performed by the tracking data store 125 (see FIGS. 2A-2D) and/or the tracking engine 124 working together with the tracking data store 125.

Turning to FIG. 6A, from a start block, the method 300 proceeds to block 310, where the end user computing device 162A receives the modified advertisement 282 pushed to the end user computing device 162A by the advertisement providing computing device 242. At block 320, the advertisement displaying application 164 (see FIG. 2B) executing on the end user computing device 162A displays the modified advertisement 282 to the end user operating the end user computing device 162A.

The end user may interact with (e.g., tap or click on) the modified advertisement 282 using a user interface of the end user computing device 162A. When this occurs, the end user computing device 162A receives the user selection via the user interface.

In decision block 325, the end user computing device 162A determines whether the end user has selected or otherwise interacted with the modified advertisement 282. The decision in decision block 325 is “YES” when the end user has selected or otherwise interacted with the modified advertisement 282. On the other hand, the decision in decision block 325 is “NO” if the end user does not interact with the modified advertisement 282.

When the decision in decision block 325 is “NO,” the method 300 proceeds to an end block and terminates. When the decision in decision block 325 is “YES,” the method 300 proceeds to block 330, where the end user computing device 162A collects the device information (e.g., the IFA, the Android ID, the MAC address, the IP address, browser information, and/or the like) associated with the end user computing device 162A, and stores that information in the tracking link 272. As mentioned above, the tracking link 272 may include macros that instruct the end user computing device 162A to collect the device information associated with the end user computing device 162A, and store that information in the tracking link 272. In some embodiments, the advertisement displaying application 164 may collect the information about the end user computing device 162A.

Next, at block 335, the tracking link 272 causes the computing device 162A to visit the destination address 274 (which, in this example, is on the tracking server 122A). In FIG. 2B, this is illustrated by arrow “A6.” In the embodiment illustrated, the tracking link 272 causes the end user computing device 162A to use the Internet browser application 166 to visit the destination address 274. In such embodiments, the Internet browser application 166 may collect the information about the end user computing device 162A. In some embodiments, the device information may be transmitted as part of a message body of an HTTP POST request, instead of (or in addition to) being transmitted as part of the tracking link 272.

Turning to FIG. 6B, from a start block, the method 400 proceeds to block 410, where the tracking engine 124 executing on the tracking server 122A collects the information stored in the tracking link 272 and/or obtains information from the HTTP header or message body received by the tracking server 122A. For example, the HTTP header may include the IP address and browser information for the end user computing device 162A by default. The tracking engine 124 stores the information received in the tracking link 272 and/or obtained from the HTTP header or message body as a user click record 422 (see FIG. 2B) in the user click records 126 stored in the tracking data store 125. In FIG. 2B, this is illustrated by arrow “A7.” By way of a non-limiting example, the device information associated with the end user computing device 162A stored in the user click record 422 may include the user's MAC address, IP address, and browser information. In some embodiments, the user click record 422 may also include a timestamp or other indicator of when the click or other interaction with the link 272 occurred.

The tracking engine 124 may also credit the appropriate party or parties (e.g., the advertisement provider associated with the advertisement providing computing device 242) for the user click. The party or parties credited may be identified in the tracking link 272. By way of a non-limiting example, a “credit” may be stored in the tracking information 182 stored on the storage service server 122B. For example, the advertisement provider records 127 may be updated to reflect the “credit” earned by the advertisement provider associated with the advertisement providing computing device 242. In some embodiments, the tracking engine 124 may include an identifier of the advertisement provider in the user click record 422, or may otherwise associate the user click record 422 with the advertisement provider, so that further analysis with respect to clicks generated by the advertisement provider may be performed later.

As mentioned above, the tracking link 272 may include the indicia associated with the address (and/or the address itself) to which to redirect the end user computing devices 162. The address is an address of one of the Application Providers 170 from which the installable application 214 may be purchased, downloaded, and/or installed. At block 420 in FIG. 6B, the tracking engine 124 redirects the end user computing device 162A to the address whereat the installable application 214 may be purchased, downloaded, and/or installed. In FIG. 2B, this is illustrated by arrow “A8.” By way of a non-limiting example, in block 420, the tracking engine 124 may issue an HTTP redirect to the Internet browser application 166 to direct the Internet browser application 166 to the application provider computing device 172. The method 400 then proceeds to an end block and terminates.

Returning to FIG. 6A, after the method 400 has been performed and the end user computing device 162A has been redirected to the address associated with the advertisement as illustrated at block 340, the end user may decide to install the application 214. However, this decision need not be made immediately following the redirect and could be made at a much later time.

In decision block 350, the computing device 162A determines whether the end user has decided to install the application 214. The decision in decision block 350 is “YES” when the end user has decided to install the application 214 and to execute it for the first time. The end user may use the user interface of the end user computing device 162A to indicate to the end user computing device 162A that the end user wishes to install and use the application 214. On the other hand, the decision in decision block 350 is “NO” if the end user decides not to install the application 214.

When the decision in decision block 350 is “NO,” the method 300 terminates. When the decision in decision block 350 is “YES,” the method 300 proceeds to block 360, where the end user computing device 162A downloads and installs the application 214. In FIG. 2B, this is illustrated by arrow “A9.” The end user may use the user interface of the end user computing device 162A to purchase, download, and/or install the application 214 in block 360. When this occurs, the end user computing device 162A receives user instructions via the user interface and in response thereto, downloads and installs the application 214.

As mentioned above, the application 214 includes the tracking SDK 216. When the installed application 214 is first used, the method 300 proceeds to block 365, where the tracking SDK 216 causes the end user computing device 162A to automatically obtain device information associated with the end user computing device 162A and send that information to the tracking engine 124 (e.g., with a “log” request). In FIG. 2C, this is illustrated by arrow “A10.” By way of a non-limiting example, the tracking SDK 216 may include one or more functions that the application developer executes from within the application 214 when one or more selected events occurs (e.g., the application is installed or executed for the first time). For example, in block 365, the tracking SDK 216 may collect the device information associated with the end user computing device 162A, and send an HTTP request to the tracking server 122A that includes the information collected. The request may optionally include the package name value (or another value) that identifies the installed application 214. Block 365 may occur in the background of the end user computing device 162A and may not alter the end user's visual experience with the executing application 214. The method 300 then proceeds to an end block and terminates.

While the method 300 and the arrows of FIG. 2B illustrate an embodiment wherein the application installation is initiated on the same end user computing device 162A as presented the advertisement, in some embodiments, multiple end user computing devices 162 may be involved in the transaction. For example, an end user may use a desktop computing device to interact with an advertisement which then directs the end user to an app store. The end user may use the desktop computing device to purchase the application, which is then installed on the mobile end user computing device 162A via a cloud download, via a sync process, or via any other suitable technique. In such embodiments, the click record generated by the desktop computing device and the install performed on the mobile end user computing device 162A may be associated by a user identifier, by a mobile device identifier known to the desktop computing device, or by any other suitable technique.

In alternate embodiments, when the method 300 (see FIG. 6A) is performed, the methods 600 and 700 (see FIGS. 7A and 7B, respectively) may be performed instead of the method 400 illustrated in FIG. 6B. FIGS. 7A and 7B are flowcharts that illustrate exemplary embodiments of the methods 600 and 700, respectively. The methods 600 and 700 are performed when the destination address is on the advertisement providing computing device 242 (instead of on the tracking server 122A). These methods may be characterized as enabling loading tracking links server-side. When the methods 600 and 700 are performed, the end user computing device 162A does not visit the tracking server 122A before being redirected to one of the application provider computing devices 172. Instead, the advertisement providing computing device 242 redirects the computing device 162A to one of the application provider computing devices 172.

The method 600 is performed by the advertisement providing computing device 242. The method 700 is performed by the tracking system 120. For ease of illustration, the method 700 will be described as being performed by the tracking engine 124 executing on the tracking server 122A. However, as is apparent to those of ordinary skill in the art, portions of the method 700 may be performed by the tracking data store 125 (see FIGS. 2A-2D) and/or the tracking engine 124 working together with the tracking data store 125.

The method 600 illustrated in FIG. 7A begins after the end user computing device 162A visits a destination address on the advertisement providing computing device 242 in block 335 of the method 300 illustrated in FIG. 6A. From a start block, the method 600 proceeds to block 610, where the advertisement providing computing device 242 collects the information stored in the tracking link 272 and/or obtains information from the HTTP header or message body received by the advertisement providing computing device 242.

In optional decision block 615, the advertisement providing computing device 242 determines whether the application 214 is already installed on the end user computing device 162A. By way of a non-limiting example, the advertisement providing computing device 242 may store or have access to records tracking which applications have been installed by at least some of the end user computing devices 162. For example, the advertisement providing computing device 242 may query the tracking data store 125 via the management interface engine 123 to determine whether the application 214 is already installed on the end user computing device 162A.

The decision in optional decision block 615 is “YES” when the advertisement providing computing device 242 determines the application 214 is installed on the end user computing device 162A. On the other hand, the decision in optional decision block 615 is “NO” when the advertisement providing computing device 242 determines the application 214 is not installed on the end user computing device 162A.

When the decision in optional decision block 615 is “NO,” or the optional decision block 615 has been omitted, the method 600 advances to block 620. At block 620, the advertisement providing computing device 242 redirects the end user computing device 162A to the address whereat the installable application 214 may be purchased, downloaded, and/or installed. By way of a non-limiting example, in block 620, the advertisement providing computing device 242 may issue an HTTP redirect to the Internet browser application 166. After block 620, the advertisement providing computing device 242 advances to a continuation terminal (“terminal A”), and block 340 of the method 300 illustrated in FIG. 6A may be performed by the end user computing device 162A.

Returning to FIG. 7A, when the decision in optional decision block 615 is “YES,” the advertisement providing computing device 242 advances to optional block 640. In optional block 640, the advertisement providing computing device 242 directs the end user computing device 162A to open the application 214. Conventional methods of directing the application displaying application 164 (e.g., the Internet browser application 166) to open the application 214 may be used in optional block 640. After optional block 640, the advertisement providing computing device 242 advances to a continuation terminal (“terminal A”). In embodiments in which the optional block 640 has been omitted, when the decision in optional decision block 615 is “YES,” the advertisement providing computing device 242 advances to terminal A.

From terminal A, the method 600 proceeds to block 630, where the advertisement providing computing device 242 sends at least a portion of the information collected in block 610 to the tracking system 120 (e.g., the tracking server 122A) so the tracking system 120 may record a user click record. Then, the method 600 proceeds to an end block and terminates.

Turning to FIG. 7B, the method 700 proceeds from a start block to block 710, where the tracking engine 124 receives the information sent by the advertisement providing computing device 242 in block 630 of the method 600 illustrated in FIG. 7A.

Returning to FIG. 7B, in block 720, the tracking engine 124 stores at least a portion of the information received in block 710 in the user click records 126 stored in the tracking data store 125. Similar to the discussion above with respect to block 410 of FIG. 6B, a user click record 422 is created and credit may be provided to an appropriate party or parties. By way of a non-limiting example, the information received in block 710, and stored in the user click record 422 (see FIG. 2B) may include the site ID value, user's MAC address value, IP address value, browser information, and a timestamp.

The tracking engine 124 may also credit the appropriate party or parties (e.g., the advertisement provider associated with the advertisement providing computing device 242) for the user click. The party or parties credited may be identified in the information received in block 710. By way of a non-limiting example, a “credit” may be stored in the tracking information 182 stored on the storage service server 122B. For example, the advertisement provider records 127 may be updated to reflect the “credit” earned by the advertisement provider associated with the advertisement providing computing device 242. In some embodiments, the tracking engine 124 may include an identifier of the advertisement provider in the user click record 422, or may otherwise associate the user click record 422 with the advertisement provider, so that further analysis with respect to clicks generated by the advertisement provider may be performed later.

Then, in optional block 730, the tracking engine 124 may send a confirmation or acknowledgement to the advertisement providing computing device 242 indicating that the tracking engine 124 received the information sent by the advertisement providing computing device 242 in block 630 of the method 600 illustrated in FIG. 7A. In the embodiment illustrated, block 720 is performed before block 730. In alternate embodiments, block 730 may be performed before block 720. Then, the method 700 proceeds to an end block and terminates.

FIG. 8 is a flowchart that illustrates an exemplary embodiment of a method 430 performed by the tracking system 120 for assigning credits for tracked installations according to various aspects of the present disclosure. For ease of illustration, the method 430 will be described as being performed by the tracking engine 124 executing on the tracking server 122A. However, as is apparent to those of ordinary skill in the art, portions of the method 430 may be performed by the tracking data store 125 (see FIGS. 2A-2D) and/or the tracking engine 124 working together with the tracking data store 125.

Turning to FIG. 8, from a start block, the method 430 proceeds to block 440, where the tracking engine 124 receives the information sent by the tracking SDK 216 in block 365 of the method 300 illustrated in FIG. 6A. The information received may be stored in an application installation record 442 in the application installation records 128 depicted in FIG. 2C. This information transfer and storage is illustrated in FIG. 2C by the arrow labeled “A11.”

Returning to FIG. 8, in block 450, the tracking engine 124 attempts to match the application installation record 442 with the information previously stored in one of the user click records 126 using first search criteria. For example, the first search criteria may specify that the device identifier (such as an IFA value and/or the like) and the site ID values between the user click record 126 and the application installation record 442 must match. The first search criteria may also include a predetermined “lookback” period (e.g., seven days). In this example, if the tracking engine 124 received the IFA value “703122b3-c066-40fc-859f-d5a8d4373c6c” and a particular site ID value from the tracking SDK 216 (in block 440), in block 450 the tracking engine 124 will attempt to find a user click record in the user click records 126 that includes the same IFA and site ID values. For ease of illustration, the user click record 422 includes the IFA value “703122b3-c066-40fc-859f-d5a8d4373c6c,” and the particular site ID value. In this example, the tracking engine 124 would locate the user click record 422 because it includes the IFA value “703122b3-c066-40fc-859f-d5a8d4373c6c,” and the particular site ID value. Then, the tracking engine 124 determines whether the user click record 422 was created within the predetermined lookback period. If the user click record 422 was created within the predetermined lookback period, the tracking engine 124 has successfully located a matching click record. If the user click record 422 was not created within the predetermined lookback period, the tracking engine 124 has failed to locate a matching click record.

By way of another non-limiting example, the first search criteria may specify that the IFA values and the package name values must match. In such embodiments, the package name value is used instead of the site ID value.

In decision block 460, the tracking engine 124 determines whether the search conducted in block 450 using the first search criteria was successful. The decision in decision block 460 is “YES” when the search conducted in block 450 was successful. For example, the decision in decision block 460 is “YES” when the tracking engine 124 locates a matching user click record created within the predetermined lookback period. On the other hand, the decision in decision block 460 is “NO” when the search conducted in block 450 was unsuccessful, or did not find a user click record created within the predetermined lookback period that matches the first search criteria.

When the decision in decision block 460 is “YES,” the method proceeds to block 465, where the tracking engine 124 assigns credit for a conversion (from a click to an install) to the advertisement 212 (see FIG. 2A) and advertisement provider (identified in the tracking link 272 and stored in the user click record 422) that led to the installation. The tracking engine 124 may store this information in the tracking information 182 stored in the tracking data store 125. For example, in some embodiments, the advertisement provider records 127 may be updated to reflect the “credit” earned by the advertisement provider associated with the advertisement providing computing device 242. In some embodiments, a financial incentive may be provided to the advertisement provider in the form of a payment transfer to an account of the advertisement provider at a financial institution, a credit to an account of the advertisement provider as tracked by the tracking system, and/or the like. In some embodiments, credit may be assigned for a conversion via method 430 dynamically during a query for attribution information from the tracking data store 125.

Optionally, the tracking data store 125 generates a tracking identifier 466 and sends the tracking identifier 466 to the tracking engine 124. In FIG. 2C, this is illustrated by arrow “A12.” Then, the tracking engine 124 sends the tracking identifier 466 (see FIG. 2C) to the tracking SDK 216. In FIG. 2C, this is illustrated by arrow “A13.” From block 465, the method 430 proceeds to a continuation terminal (“terminal A”).

When the decision in decision block 460 is “NO,” the tracking engine 124 may advance to optional decision block 470. In embodiments in which optional decision block 470 is omitted, the tracking engine 124 advances directly from block 460 to block 480.

In optional decision block 470, the tracking engine 124 tries to locate a matching user click record (for the application installation record 442) using different second search criteria than that used in block 450. For example, the tracking engine 124 may try to match the site ID (or the package name) and a device fingerprint (such as one or more of an IP address, device brand, device model values, and/or the like) received from the tracking SDK 216 (in block 440) with information stored in the user click records 126. The second search criteria may also include a predetermined lookback period (e.g., twenty-four hours). The predetermined lookback period of the second search criteria may be the same as the predetermined lookback period of the first search criteria, or may be different.

The decision in optional decision block 470 is “YES” when the tracking engine 124 locates a user click record using the second search criteria. For example, the decision in optional decision block 470 is “YES” when the tracking engine 124 locates a matching user click record created within the predetermined lookback period. When the decision in optional decision block 470 is “YES,” the tracking engine 124 advances to block 465 to assign credit to the entities associated with the user click record as described above. On the other hand, the decision in optional decision block 470 is “NO” when the tracking engine 124 fails to locate a user click record using the second search criteria. When the decision in optional decision block 470 is “NO,” the method 430 proceeds to block 480.

At block 480, the tracking engine 124 records the installation as an “organic install” (e.g., in the tracking information 182 stored on the storage service server 122B) to indicate that the installation occurred without matching a user click record. Then, the method 430 advances to a continuation terminal (“terminal A”).

From terminal A, the method 430 may advance to optional block 467. In embodiments that omit the optional block 467, the method 430 proceeds to an end block and terminates from terminal A.

In optional block 467, the tracking engine 124 may send a “server postback” to one or more of the Advertisers/Merchants 130, the Mobile Advertising Networks 140, and/or the Mobile Advertising Publishers 150 that includes the information recorded on the tracking server 122A and/or the storage service server 122B. For example, the server postback may include the information stored in the application installation record 442 and matching user click record 422. In FIG. 2C, arrow “A14” depicts server postback 482 to the customer, and arrow “A15” depicts server postback 484 to the advertisement provider. Each of the server postbacks 482 and 484 provides a copy of at least a portion of the information recorded on the tracking server 122A and/or the storage service server 122B that the recipient can use for a variety of purposes. Then, the method 430 proceeds to an end block and terminates.

To make searching and matching more efficient, the device information associated with the computing devices 162 (e.g., the IP address values, IFA values, Open UDID values, and the like) may be indexed (e.g., the index 129B) by the tracking data store 125. The tracking engine 124 may use the index 129B when searching for a match in block 450 and/or optional decision block 470.

### In-App Tracking and Re-Engagement

As mentioned above, the application developer may specify that particular functions and/or procedures within the tracking SDK 216 are executed whenever one or more selected application events occur. Non-limiting examples of in-app events include level-ups, in-app purchases, user interactions with interface elements, account creations, and/or the like. In some embodiments, credit may be provided to advertisement providers 150 for driving re-engagement with the application that causes such in-app events to occur. Tracking and providing such credit may be useful when the end user installed the application 214 several months ago, and the application provider 170 would like provide compensation to advertisement providers 150 for getting the end user to reopen the application 214 and complete an action or event, such as an in-app purchase. Thus, those advertisement providers 150 who cause end users to re-engage with the application 214 receive credits for such re-engagement. Re-engagement may be particularly useful for applications that are typically used infrequently.

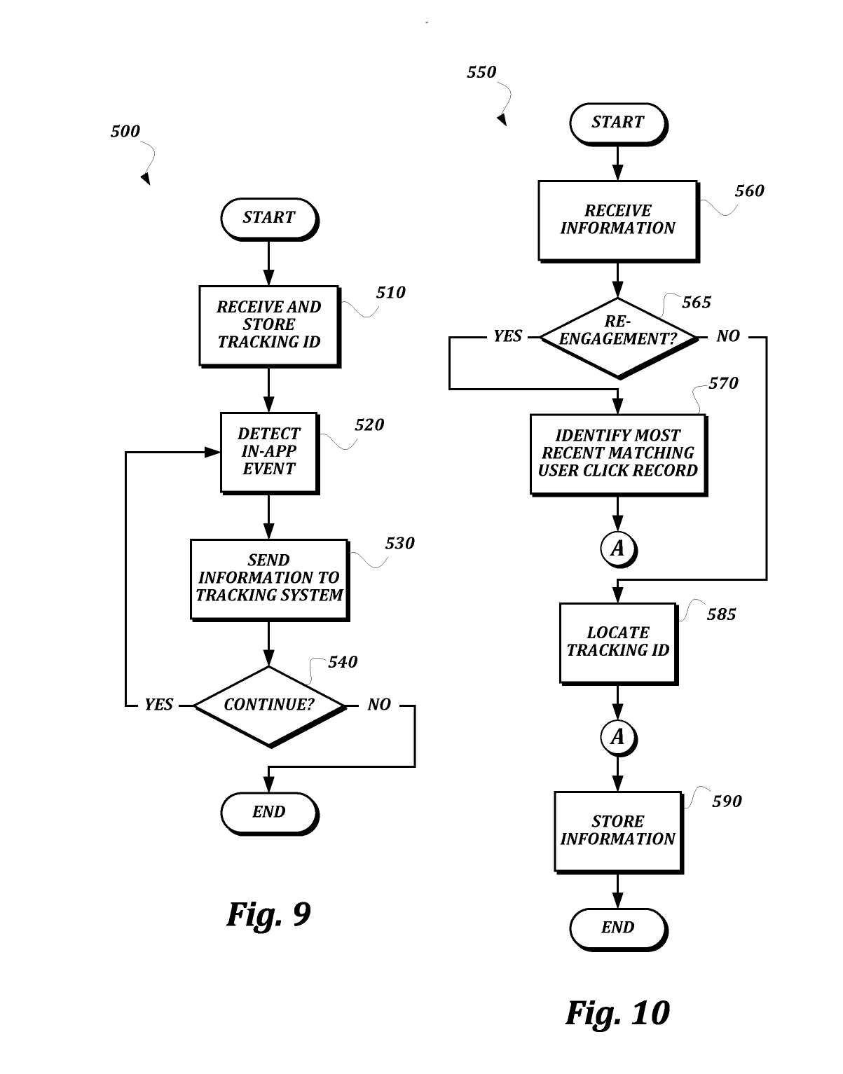

FIG. 9 is a flowchart that illustrates an exemplary embodiment of a method 500 performed by one of the end user computing devices 162 according to various aspects of the present disclosure. For ease of illustration, the method 500 will be described as being performed by the end user computing device 162A.

From a start block, the method 500 proceeds to block 510, where the tracking SDK 216 executing on the computing device 162A receives the tracking identifier 466 (see FIG. 2C) via the network 180 from the tracking engine 124 executing on the tracking server 122A. The tracking SDK 216 stores the tracking identifier 466 for subsequent use.

In block 520, the tracking SDK 216 detects an in-app event has occurred. In block 530, the tracking SDK 216 sends information to the tracking server 122A upon the detection of the application event. The information includes at least the tracking identifier 466. In some embodiments, the information may also include a purchase price or other revenue information if the tracked in-app event was a purchase or other revenue generating event. In some embodiments, the information may also include an indication of whether re-engagement has been enabled for the tracked in-app event. In some embodiments, the information may include the site ID value or the package name value (to identify the application 214) and the device information that may be used to locate a matching user click record stored for the computing device 162A and the application 214. In some embodiments, the information may also include a description or identification of a particular in-app event that occurred. In each of these embodiments, the application developer may cause the additional information to be included with the tracking identifier 466 when sent to the tracking server 122A. In some embodiments, the tracking SDK 216 may identify whether or not re-engagement has been enabled, instead of receiving an indication of such enablement as part of the information.

In decision block 540, the tracking SDK 216 determines whether to continue monitoring for the occurrence of in-app events. The decision in decision block 540 is “YES,” when the tracking SDK 216 decides to continue monitoring for the occurrence of in-app events. On the other hand, decision in decision block 540 is “NO,” when the tracking SDK 216 decides not to continue monitoring for the occurrence of in-app events. By way of a non-limiting example, the decision in decision block 540 is “YES” as long as the application 212 is executing. Otherwise, the decision in decision block 540 is “NO.”

When the decision in decision block 540 is “YES,” the tracking SDK 216 returns to block 520. On the other hand, when the decision in decision block 540 is “NO,” the method 500 proceeds to an end block and terminates.

FIG. 10 is a flowchart that illustrates an exemplary embodiment of a method 550 performed by the tracking system 120 for assigning credit for in-app events according to various aspects of the present disclosure. For ease of illustration, the method 500 will be described as being performed by the tracking engine 124 executing on the tracking server 122A.

From a start block, the method 550 proceeds to block 560, where the tracking engine 124 receives the information sent by the tracking SDK 216, as described in block 530 of the method 500 illustrated in FIG. 9 and discussed above. The information includes at least the tracking identifier 466 (see FIG. 2C).

In decision block 565, the tracking engine 124 determines whether re-engagement has been enabled in association with the event being reported by the information received. If re-engagement is not enabled, the in-app event indicated by the information received is attributed (or credited) to the same entity or entities who received credit for the installation of the application 214 as discussed above and as indicated in the tracking data store 125. On the other hand, if re-engagement is enabled, the in-app event indicated by the information received may be credited to one or more advertisement providers who recently interacted with the end user. An indication of whether re-engagement has been enabled may be included in the information received in block 560.

The decision in decision block 565 is “YES” when re-engagement has been enabled. On the other hand, the decision in decision block 565 is “NO” when re-engagement has not been enabled. When the decision in decision block 565 is “NO,” the method 550 advances to block 585. At block 585, the tracking engine 124 uses the tracking identifier 466 (and optionally the index 129B) to identify the application installation record 442 associated with the computing device 162A and the application 212, and the user click record 422 (or records) matched with the application installation record 442. The method 550 then proceeds to a continuation terminal (“terminal A”).

When the decision in decision block 565 is “YES,” the method 550 advances to block 570. At block 570, the tracking engine 124 matches the information received in block 560 with the information previously stored in one or more of the user click records 126. For example, the tracking software 124 may search for matching user click records using a third search criteria similar to the first search criteria or second search criteria discussed above (e.g., matching device identifier and site ID values, matching device fingerprint and site ID values, and/or the like). The method 550 then proceeds to a continuation terminal (“terminal A”).

From terminal A, the method 550 proceeds to block 590, where the tracking engine 124 stores the information received in block 560 and associates it with the application installation record 442 and the matching user click records 422. The tracking engine 124 may store this information in the tracking information 182 stored in the tracking data store 125. For example, in some embodiments, the advertisement provider records 127 may be updated to reflect the “credit” earned by the advertisement provider associated with the advertisement providing computing device 242. In some embodiments, a financial incentive may be provided to the advertisement provider in the form of a payment transfer to an account of the advertisement provider at a financial institution, a credit to an account of the advertisement provider as tracked by the tracking system, and/or the like. In some embodiments, credit may be assigned for a re-engagement via method 550 dynamically during a query for attribution information from the tracking data store 125.

Then, the method 550 proceeds to an end block and terminates.

### Determining Influence of Acquired Users

Many online advertisers 130 compensate third parties (e.g., advertisement publishers 150, advertising networks 140, and/or the like) who display advertisements to visitors of their websites and/or users of their software applications (e.g., applications such as the application 214) as described above. However, advertisers 130 particularly desire the acquisition of influential end users who are likely to drive additional traffic to their web site or additional installs and usage of their application 214. Accordingly, in some embodiments, the tracking system 120 is configured to determine which users are more influential than others, and to provide credit for acquisition of such users.

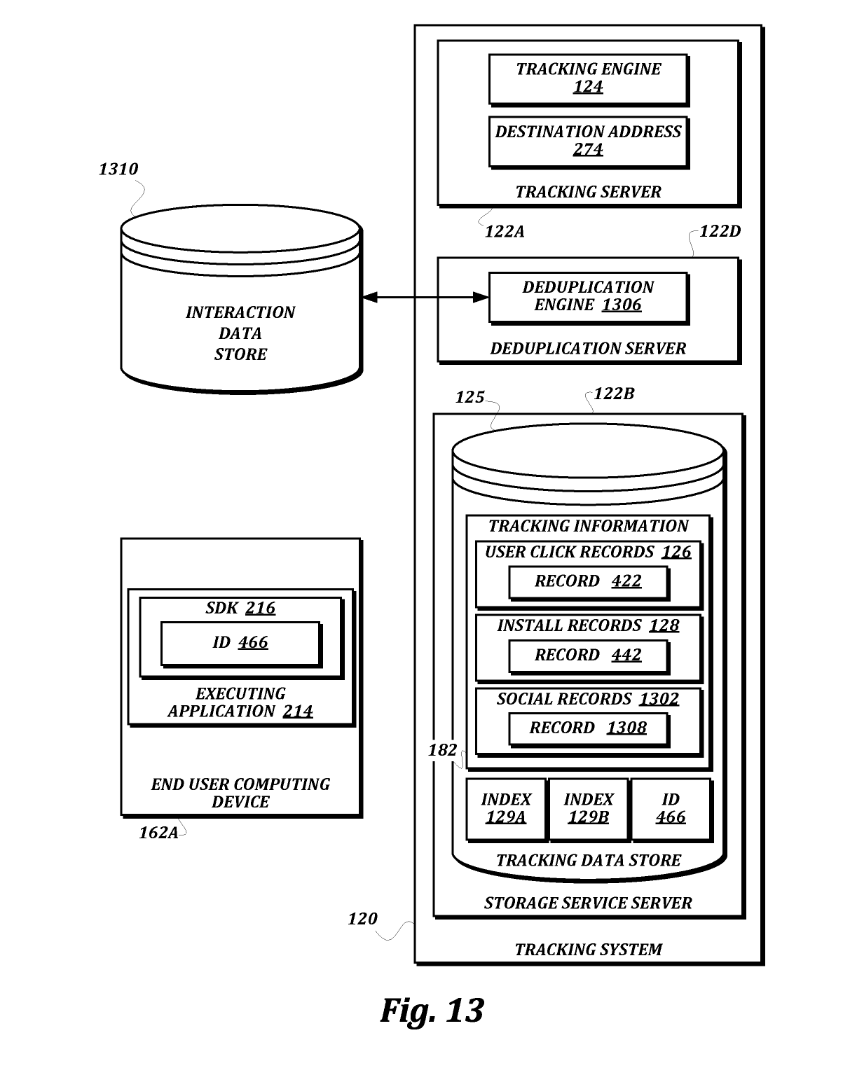

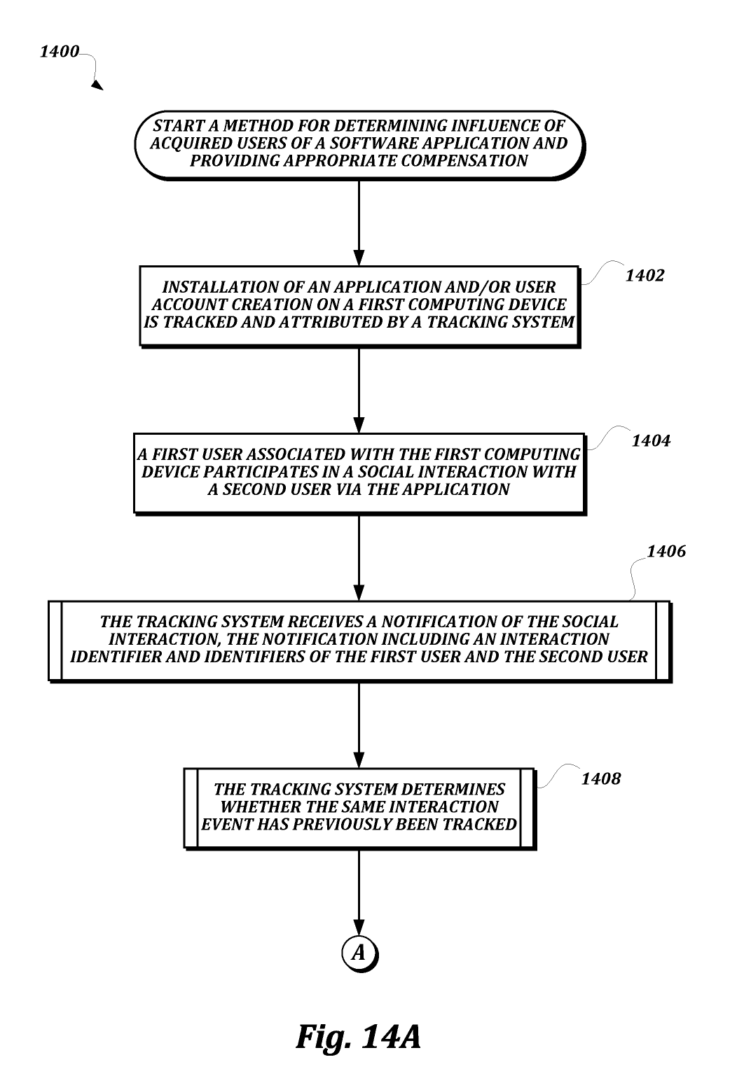

FIG. 13 is a block diagram that illustrates an exemplary embodiment of a tracking system 120 as discussed above that includes features for determining influence of acquired users and providing appropriate compensation according to various aspects of the present disclosure. As illustrated in FIG. 13, the tracking data store 125 is configured to store tracking information 182 similar to the tracking information 182 described above, but that also includes a set of social records 1302. The social records 1302 represent social interactions performed by users of the executing application 214. Each time the tracking system 120 detects a social interaction by a user, a social record 1308 is added or updated for the user. By counting these social interactions, the tracking system 120 may determine which users perform the most social interactions, and are therefore more valuable users for advertising and other purposes.

The tracking system 120 also includes a deduplication server 122D. A deduplication engine 1306 executed by the deduplication server 122D is configured to efficiently determine whether an interaction detected by the tracking system 120 has been previously tracked, or whether it is a new unique interaction. In some embodiments, an interaction is considered “unique” if the participants in the interaction are unique, regardless of which participant initiated the interaction. For example, an email sent from a first user (“User A”) to a second user (“User B”) in the absence of previous emails sent between User A and User B would be recorded as a unique interaction. Subsequently, an email sent from User B to User A would be considered a duplicate interaction, because an interaction between those two users was previously recorded. Likewise, a new email between User A and User B sent in the future would also be considered a duplicate interaction, but a new email between User A and a third user (“User C”) would be considered a unique interaction.

In some embodiments, the deduplication engine 1306 communicates with an interaction data store 1310 to support the deduplication functionality. The interaction data store 1310 may be capable of efficiently storing massive numbers of deduplication records, and may also be capable of quickly determining whether or not a new interaction is a duplicate. A large scale data store may be used to support this functionality because such data store technology is specialized for large-scale information storage and query operations. One example data store suitable for providing the interaction data store 1310 is the DynamoDB provided by Amazon. DynamoDB is a managed NoSQL database service that automatically spreads data and traffic over multiple servers to handle a request capacity specified by the tracking system 120 and an amount of data stored while maintaining consistent and fast performance. In some embodiments, a different data store technology is used that is also able to provide these performance characteristics.

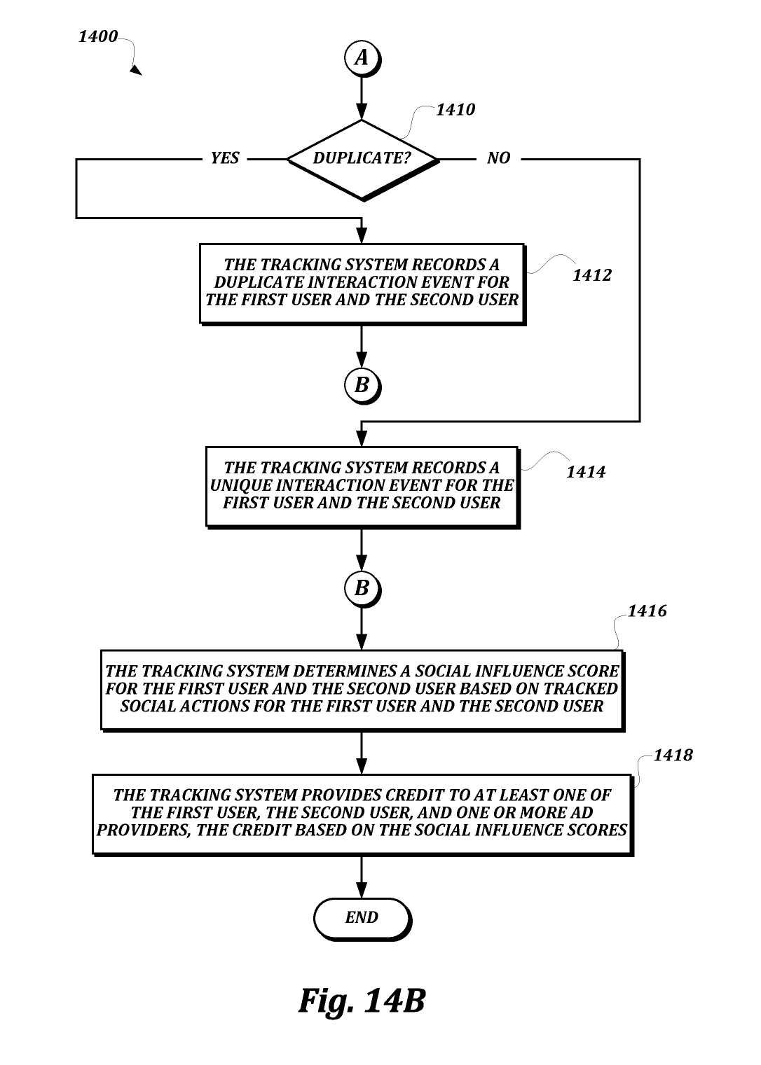

FIGS. 14A-14B are a flowchart that illustrates an exemplary embodiment of a method 1400 for determining influence of acquired users of a software application and providing appropriate compensation according to various aspects of the present disclosure. From a start block, the method 1400 proceeds to block 1402, where installation of an application 214 and/or user account creation on a first computing device 162A is tracked and attributed by a tracking system 120. The installation and/or user account creation may be tracked and attributed by the tracking system 120 using techniques such as those illustrated and discussed above with respect to FIGS. 3-10 and the associated text.

The method 1400 then proceeds to block 1404, where a first user associated with the first computing device 162A participates in a social interaction with a second user via the application. The social interaction may be any type of social interaction supported by the executing application 214. If the executing application 214 supports communication on a social media platform, the social interaction could be a typical interaction that takes place on the social media platform, such as a comment on a social media post, an affinity indicator (e.g. a “like,” a “favorite,” a “plus-one”, and/or the like), a message, and/or any other suitable type of communication. In some embodiments, a social interaction could be a form of communication through the executing application 214. For example, if the executing application 214 is a multiplayer game, a social interaction may include a first user starting a session of the game with a second user. As another example, if the executing application 214 is intended to enable communication between users (e.g. a chat application, an email application, and/or the like), then communications within the application may constitute social interactions. Furthermore, while social interactions are primarily described herein as taking place between a first user and a second user, this simple example is used for ease of discussion only. In some embodiments, a social interaction may take place between any number of users.

At procedure block 1406, a procedure occurs wherein the tracking system 120 receives a notification of the social interaction, the notification including an interaction identifier and identifiers of the first user and the second user. In some embodiments, the interaction identifier may be omitted, and the identifiers of the first user and the second user may be used by themselves to identify the interaction.

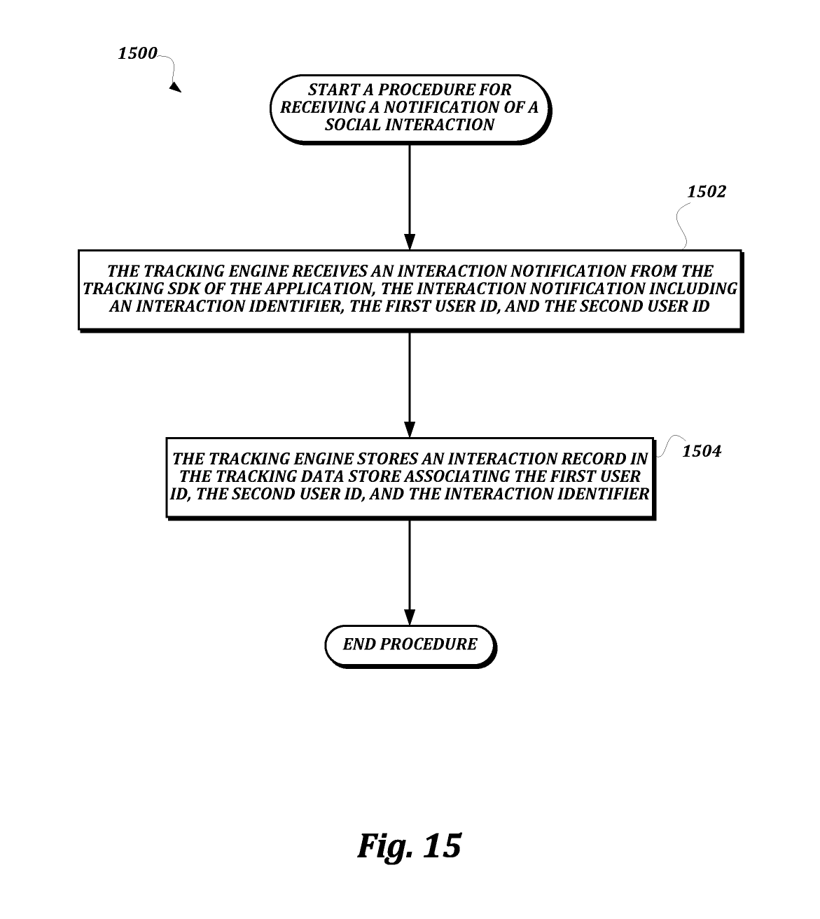

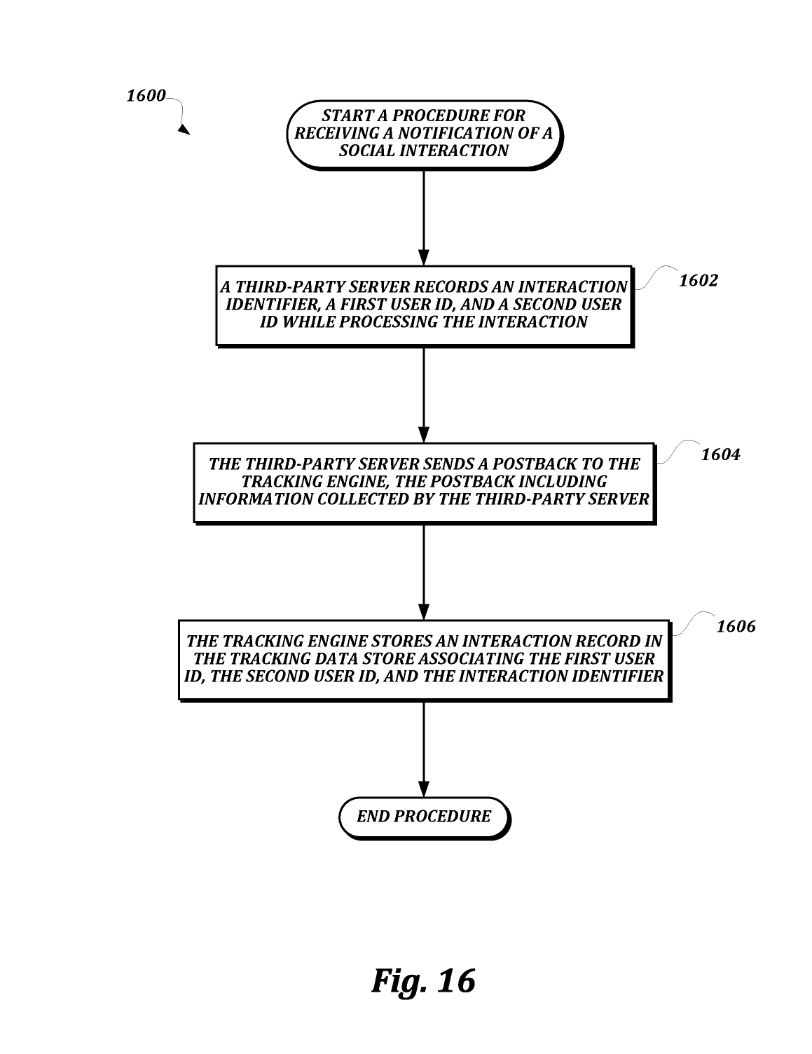

In some embodiments, the identifiers of the first user and the second user may be user names, login names, email addresses, handles, phone numbers, or the like, that are used within the application to address interactions between the users. In some embodiments, user identifiers may be inferred based on the tracking identifier 466, the device identifier, a device fingerprint, and/or the like. In some embodiments, the interaction identifier may be generated by the application 214 or a platform with which the application 214 interacts to uniquely identify a given interaction, such as a Message-ID, a Twitter tweet ID, a Facebook post-id, and/or any other suitable identifier. In some embodiments, the notification of the social interaction may indicate which user was the sending or initiating user. In some embodiments, the notification of the social interaction may not indicate which user was the sending or initiating user, and merely represents the fact that the users interacted in some way. FIGS. 15 and 16, along with their accompanying text, illustrate and describe two example procedures by which the tracking system 120 may receive the notification of the social interaction.

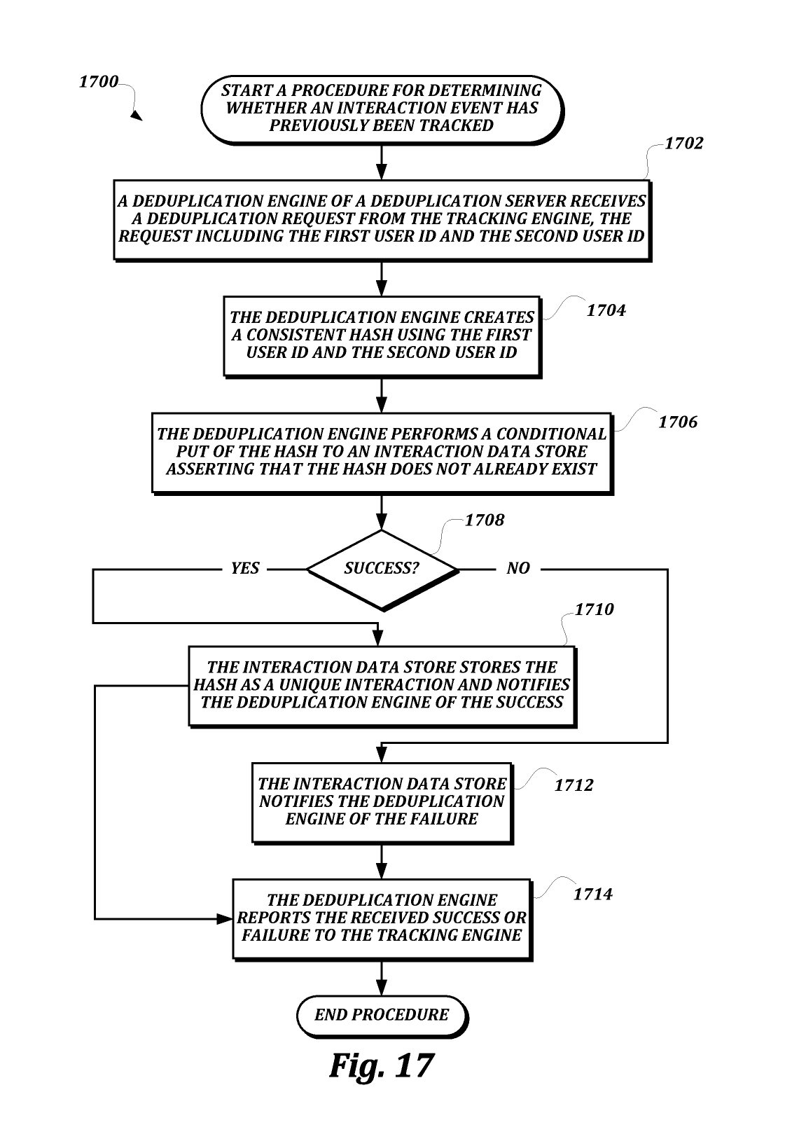

At procedure block 1408, a procedure occurs wherein the tracking system 120 determines whether the same interaction event has previously been tracked. In some embodiments, an interaction event is considered previously tracked if a previous interaction event includes the same set of users. FIG. 17, along with its accompany text, illustrates and describes an example procedure by which the tracking system 120 may determine whether the same interaction event has previously been tracked.

The method 1400 then proceeds to a continuation terminal (“terminal A”). From terminal A (FIG. 14B), the method 1400 proceeds to decision block 1410, where a test is performed based on the determination of whether the same interaction event has previously been tracked. If the determination was that the interaction event had previously been tracked and is therefore a duplicate, the result of the test is YES, and the method 1400 proceeds to block 1412, where the tracking system 120 records a duplicate interaction event for the first user and the second user. In some embodiments, the duplicate interaction event is recorded by the tracking engine 124 in the tracking data store 125. In some embodiments, the duplicate interaction event is created as a new record 1308 in the social records 1302. In such embodiments, the record 1308 may include further information regarding the interaction event, such as a timestamp of the interaction, the interaction identifier, and/or the like. In some embodiments, the duplicate interaction event is recorded by updating a previously stored record 1308 in the social records 1302. That is, an interaction record 1308 may have been recorded for a previous unique interaction event between the first user and the second user that stored an interaction count of 1. Upon detection of the duplicate interaction event, the tracking engine 124 may increment the interaction count recorded in the previously stored record 1308. From block 1412, the method 1400 proceeds to a continuation terminal (“terminal B”).

Otherwise, if the determination was that the interaction event had not previously been tracked, the result of the test is NO, and the method 1400 proceeds to block 1414, where the tracking system 120 records a unique interaction event for the first user and the second user. [refer to social records 1302/1308; what identifiers are in there; what other info might be stored in there] From block 1414, the method 1400 proceeds to terminal B.

From terminal B, the method 1400 proceeds to block 1416, where the tracking system 120 determines a social influence score for the first user and the second user based on tracked social actions for the first user and the second user. In some embodiments, a social influence score may be calculated for a user by simply counting the number of unique interactions for the user and using the raw count as the social influence score. In some embodiments, a social influence score may also be based on a count of the number of duplicate interactions for the user, though duplicate interactions may not receive a different weight than unique interactions. In some embodiments, further processing may be performed. For example, the count of unique interactions may be normalized and/or scaled based on the distribution of counts for all users in order to more easily compare social influence scores between users. As another example, the count of unique interactions may be used to place the user in one or more ranges or “buckets,” and the bucket in which the user is placed may determine the social influence score (e.g., 0-5 unique interactions would be a 1-star user, 6-10 unique interactions would be a 2-star user, 11-20 unique interactions would be a 3-star user, and more than 20 interactions would be a 4-star user). In some embodiments, the tracking system 120 may also measure a user's engagement with the application 214 over time. Exemplary embodiments of techniques for measuring user engagement with the application are described in commonly owned, co-pending U.S. patent application Ser. No. 14/473,948, filed Aug. 29, 2014, the entire disclosure of which is hereby incorporated herein for all purposes. The social influence score and the engagement information may be used to create statistics and analytics, including but not limited to a lifetime value, a return on investment, a user social value, a viral impact score, an amplification rate, an applause rate, and economic value.

The method 1400 then proceeds to block 1418, where the tracking system 120 provides credit to at least one of the first user, the second user, and one or more ad providers based on the social influence scores. As discussed elsewhere herein, a credit may include a financial incentive, an indication of the assigned credit in a report, and/or any other suitable reward for encouraging the tracked activity. In some embodiments, the ad provider that receives the credit may be determined based on a technique similar to that described above for attributing initial acquisition of the user, initial installation of the application, and/or re-engagement with the application. In some embodiments, more than one ad provider may be provided credit for the activity, as described in commonly owned, co-pending U.S. patent application Ser. No. 14/304,757, filed Jun. 13, 2014, the entire disclosure of which is hereby incorporated herein for all purposes.

The method 1400 then proceeds to an end block and terminates.

FIG. 15 is a flowchart that illustrates an exemplary embodiment of a procedure 1500 for receiving a notification of a social interaction according to various aspects of the present disclosure. The procedure 1500 is an example of a procedure suitable for use at block 1406 of the method 1400 illustrated in FIGS. 14A-14B and described above.

From a start block, the procedure 1500 proceeds to block 1502, where the tracking engine 124 receives an interaction notification from the tracking SDK 216 of the application 214, the interaction notification including an interaction identifier, the first user identifier, and the second user identifier. In some embodiments, the interaction notification may be generated and received using a technique similar to the in-app notification illustrated in FIG. 9 and described above. As also discussed above, the interaction notification may include identifiers from more than two users, but two users are referred to here for ease of discussion. At block 1504, the tracking engine 124 stores an interaction record 1308 in the tracking data store 125 associating the first user identifier, the second user identifier, and the interaction identifier. The procedure 1500 then proceeds to an end block and terminates.

FIG. 16 is a flowchart that illustrates another exemplary embodiment of a procedure 1600 for receiving a notification of a social interaction according to various aspects of the present disclosure. The procedure 1600 is another example of a procedure suitable for use at block 1406 of the method 1400 illustrated in FIGS. 14A-14B and described above.

From a start block, the procedure 1600 proceeds to block 1602, where a third-party server records an interaction identifier, a first user identifier, and a second user identifier while processing the interaction. The third-party server may be any type of server used by the application 214 that obtains interaction information. Some examples of third-party servers that can directly supply event data in this way include but are not limited to servers operated by social media platforms such as Facebook, Twitter, LinkedIn and/or the like; review posting sites such as Yelp and/or the like; and social games such as Clash of Clans, CandyCrush, and/or the like.

At block 1604, the third-party server sends a postback to the tracking engine 124, the postback including information collected by the third-party server. The information includes at least the first user identifier and the second user identifier, and could also include other information about the users and/or the interaction that was collected by the third-party server. At block 1606, the tracking engine 124 stores an interaction record 1308 in the tracking data store 125 associating the first user identifier, the second user identifier, and the interaction identifier. The procedure 1600 then proceeds to an end block and terminates.

FIG. 17 is a flowchart that illustrates an exemplary embodiment of a procedure 1700 for determining whether an interaction event has previously been tracked according to various aspects of the present disclosure. The procedure 1700 is an example of a procedure suitable for use at block 1408 of the method 1400 illustrated in FIGS. 14A-14B and described above.

From a start block, the procedure 1700 proceeds to block 1702, where a deduplication engine 1306 of a deduplication server 122D receives a deduplication request from the tracking engine 124, the request including the first user identifier and the second user identifier. Next, at block 1704, the deduplication engine 1306 creates a consistent hash using the first user identifier and the second user identifier.

One example of a technique for creating a consistent hash using the user identifiers is to place the user identifiers in alphabetical order and to combine them in a string. For example, in an interaction between a user with the identifier “Zach” and a user with the identifier “Amy,” the deduplication engine 1306 may combine the user identifiers in alphabetical order to create the string “Amy-Zach” for the hash regardless of whether “Amy” is the first user or “Zach” is the first user. In this way, any future tracked interaction between “Amy” and “Zach” will generate the same hash string, regardless of which user initiated the interaction. Similarly, any interaction between users named “Dan,” “Aaron,” and “Peter” would generate a hash string similar to “Aaron-Dan-Peter” regardless of the order of the users in the interaction notification. Ordering user identifiers in this way may be used regardless of the content of the user identifiers. That is, even if the user identifiers are numbers, they may still be placed in alphabetical (or numerical) order to create the hash string.

In some embodiments, the hash string may be further processed to create a numerical hash value that represents the hash string. Some information about the interaction (such as which user initiated the interaction) is lost by reordering and hashing the user identifiers. However, since the goal of the deduplication process is to identify unique interactions and that goal can be achieved without any other information, this reordering and hashing improves efficiency of the procedure 1700 without sacrificing its core functionality. Also, creating a numerical hash from the hash string can help protect the privacy of the users and may possibly improve performance over having to process queries over string data.

The procedure 1700 then proceeds to block 1706, where the deduplication engine 1306 performs a conditional put of the hash to an interaction data store 1310 asserting that the hash does not already exist. As understood by one of ordinary skill in the art, a conditional put is a database operation in which the truth of a statement is asserted before the data is stored in the database. If the statement is determined to be false, the data is not stored in the database and the failure is reported to the requester. As discussed above, the interaction data store 1310 is capable of very fast execution of conditional put operations even for very large databases.

Next, at decision block 1708, a test is performed based on the result of the conditional put in block 1706. If the conditional put was successful, then the result of the test at decision block 1708 is YES, and the procedure 1700 proceeds to block 1710, where the interaction data store 1310 stores the hash as a unique interaction and notifies the deduplication engine 1306 of the success. The procedure 1700 then proceeds to block 1714. Otherwise, if the conditional put was unsuccessful (indicating that the hash had previously been stored in the interaction data store 1310), then the result of the test at decision block 1708 is NO, and the procedure 1700 proceeds to block 1712, where the interaction data store 1310 notifies the deduplication engine of the failure. The procedure 1700 then proceeds to block 1714.

At block 1714, the deduplication engine 1306 reports the received success or failure to the tracking engine 124. The procedure 1700 then proceeds to an end block and terminates.

### Presentation of Metrics

Turning to FIG. 2D, the management interface (e.g., the reports page 224 illustrated in FIG. 11B) generated by the management interface engine 123 may be used to view portions of the tracking information 182 and generate reports based at least in part on the tracking information 182 stored in the tracking data store 125 on the storage service server 122B. One or more of the Advertisers/Merchants 130, the Mobile Advertising Networks 140, and/or the Mobile Advertising Publishers 150 may use the management interface (e.g., the reports page 224 illustrated in FIG. 11B) generated by the management interface engine 123 to generate reports. For ease of illustration, in FIG. 2D, the customer computing device 132A is illustrated using the management interface to generate the reports page 124 illustrated in FIG. 11B.

In the embodiment illustrated in FIG. 2D, the computing device 132A executes a conventional Internet browser application 800. The Internet browser application 800 displays webpages generated by the management interface engine 123 and transmits user input received from the end user to the management interface engine 123.

In FIG. 2D, an arrow “A16” represents a request sent by the Internet browser application 800 (in response to a user instruction received via a user interface) to the management interface engine 123 for the reports page 224.

When the management interface engine 123 receives the request, the management interface engine 123 sends a request to the tracking data store 125 for information used to generate the reports page 224. This request is represented in FIG. 2D by arrow “A17.”

In response to the request sent by the management interface engine 123, the tracking data store 125 obtains the information requested and sends the information to the management interface engine 123. This request is represented in FIG. 2D by arrow “A18.”

After the management interface engine 123 receives the information from the tracking data store 125, the management interface engine 123 generates the reports page 224 and sends it to the Internet browser application 800 for display thereby to the end user. This request is represented in FIG. 2D by arrow “A19.”

By way of non-limiting examples, the management interface engine 123 may allow the Advertisers/Merchants 130, the Mobile Advertising Networks 140, and/or the Mobile Advertising Publishers 150 to access one or more of the following types of information:

1. User Click Data;

2. User Install Data;

3. User Event Data;

4. Publisher Payouts;

5. Install Rate;

6. Cost Per Click;

7. Revenue Per Install;

8. Social Interaction Data, including individual and aggregate social influence scores for tracked users; and

9. Other Relevant Information, including attributed installs and/or re-engagements, install and/or re-engagement assists, and non-windowed install and/or re-engagement contributions.

Depending upon the implementation details, the management interface engine 123 may be used to aggregate information and provide analytics (e.g., graphs) to the Advertisers/Merchants 130, the Mobile Advertising Networks 140, and/or the Mobile Advertising Publishers 150 that may be used thereby to improve the effectiveness of advertising campaigns.

The storage service server 122B may organize and index the tracking information 182. Optionally, the tracking server 122A may include a storage engine (not shown) substantially similar to the storage engine 125 executing on the storage service server 122B.

FIG. 11B is an illustration of an exemplary reports page 224 generated by the management interface engine 123. The reports page 224 includes a graph 802. Each line (e.g., lines 804A and 804B) on the graph 802 depicts data for a select application (e.g., the application 214). For ease of illustration, in FIG. 11B, the graph 802 includes the line 804A, which depicts data for the application 214, and the line 804B, which depicts data for a different application (“Application B”) marketed by the same customer as the application 214. Thus, on the graph 802, multiple lines may be used to depict data for multiple applications.

The x-axis is a predetermined date range. A user input 806 may be used to specify the predetermined date range. The y-axis is a number of events tracked by the tracking system (e.g., installs, clicks, install assists, non-windowed install contributions, and the like). A user input 810 may be used to select the type of event. For example, the user input 810 may allow the user to select “installs,” “clicks,” and/or the like.

A user input 808 may be used to select “publishers,” “organics,” or “totals.” If “publishers” is selected, only events attributable to an advertising provider will be included in the graph 802. If “organics” is selected, only events not attributable to an advertising provider will be included in the graph 802. If “totals” is selected, all events will be included in the graph 802.

In FIG. 11B, “publishers” has been selected in the user input 808, and “installs” has been selected in the user input 810. Thus, the line 804A depicts a number of installs of the application 214 from April 10 to April 17 that were attributed to one of the advertising providers. The graph 802 may be used to evaluate the overall effectiveness of an advertising campaign.

The reports page 224 includes an area 820 in which information about each of the applications marketed by the customer may be displayed. In this example, buttons or links are associated with each application. The customer may select the buttons or links to view more information about each application. In FIG. 11B, the buttons include a publishers button 821, a campaigns button 822, and an organic button 823. When one of these buttons is clicked, a new table or graph (not shown) may be displayed that may help the customer evaluate (1) the effectiveness of particular publishers with respect to getting users to download the application, (2) the effectiveness of particular campaigns, and/or (3) the number of applications that are downloaded organically.

The reports page 224 includes a performance graph 830 and a budget graph 832. The graphs 830 and 832 may be used to show total customer numbers for all of the customer's applications. For example, the performance graph 830 may be used to depict a total number of clicks and installs the customer is experiencing for all of its applications over the predetermined date range. The budget graph 832 may be used to depict a payout amount and an amount of revenue generated by all of the customer's applications over the predetermined date range. The graphs 830 and 832 may help provide an overview of how well the customer is doing overall.

In embodiments in which action assists and/or non-windowed action contributions are tracked by the tracking system 120, such information may also be presented in the reports page 224 or in another suitable interface. For example, the reports page 224, when presented to an advertiser 130, may allow the advertiser 130 to select one or more ad providers, and may then present a comparison of attributed installs, install assists, and/or non-windowed install contributions for each of the ad providers in graph or tabular format. This allows the advertiser 130 to determine an overall effectiveness of an advertising campaign, and the comparison of attributed installs to install assists can help the advertiser 130 determine which ad providers are effectively driving installations, and which ad providers are effectively building awareness. The presentation of non-windowed install contribution information also allows the advertiser 130 to meaningfully compare ad provider performance even for ad providers that have attribution windows of different lengths.

Access to reporting information may not be limited to advertisers 130. In some embodiments, advertising publishers 150 and/or advertising networks 140 may be provided access to reporting data as well. In some embodiments, advertising publishers 150 may be provided access to a subset of the tracking information and metrics in order to allow the advertising publishers 150 to analyze their performance without disclosing sensitive information. For example, in some embodiments, advertising publishers 150 may be provided access to logs of attributed installs or re-engagements for which they have been provided credit, but they may be prevented from accessing logs of assists or non-windowed contributions and may instead only be given access to aggregated performance counts. Further, information that falls outside of the publisher's attribution window may be hidden from the publisher, even if it is collected and made available to advertisers 130. For example, non-windowed install contributions may be hidden from advertising publishers 150 to prevent advertising publishers 150 from using the information to change their billing models to maximize total potential conversions (e.g., by altering their attribution window policies).

Computing Device

FIG. 12 is a diagram of hardware and an operating environment in conjunction with which implementations of the one or more computing devices of the system 100 may be practiced. The description of FIG. 12 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 12 includes a general-purpose computing device in the form of the computing device 12. Each of the computing devices of FIGS. 1 and 2A-2D (including the computing devices 122, 132, 142, 152, 162, 172, and 242) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface. The user interface is configured to display portions of the management interface (e.g., the tracking link page 222 illustrated in FIG. 11A, the reports page 224 illustrated in FIG. 11B, and the like) to the End Users 160.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 12 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 200, 250, 290, 300, 400, 600, 700, 430, 500, 550, and 1400 illustrated in FIGS. 3, 4, 5, 6A, 6B, 7A, 7B, 8, 9, 10, and 14A-B, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims.

The embodiments of the invention in which an exclusive property or privilege is claimed are defined as follows:

1. A system for counting unique user interactions within an application, the system comprising:
a tracking data store configured to:
store unique interaction counts for a plurality of users of the application; and a tracking server configured to:
collect interaction records, wherein each interaction record identifies two or more users engaging in an interaction using the application;
determine unique interaction counts for users of the application based on the collected interaction records; and
store the unique interaction counts in the tracking data store.

2. The system of claim 1, wherein the tracking server is further configured to:
receive an in-app event notification from the application executing on a client computing device; and
create an interaction record based on the in-app event notification.

3. The system of claim 1, wherein the tracking server is further configured to:
receive a postback event notification from a third-party server; and
create an interaction record based on the postback event notification.

4. The system of claim 1, further comprising a duplicate detection server configured to determine whether an interaction record collected by the tracking server represents a duplicate interaction event or a unique interaction event.

5. The system of claim 4, wherein determining whether an interaction record represents a duplicate interaction event or a unique interaction event includes:
calculating a hash value that represents two or more participants in an interaction associated with the interaction record; and
determining whether a previous interaction is represented by a matching hash value.

6. The system of claim 5, further comprising an interaction data store configured to store a plurality of interaction records.

7. The system of claim 6, wherein the interaction data store is further configured to:
receive a request from the tracking server to perform a conditional put of a hash value representing two or more participants in an interaction;
determine whether the hash value is already stored in an interaction record; and
in response to determining that the hash value is not already stored in an interaction record:
store the hash value as a unique interaction; and
report a successful result to the tracking server.

8. The system of claim 7, wherein the interaction data store is further configured to, in response to determining that the hash value is already stored in an interaction record:
store the hash value as a duplicate interaction; and
report a failed result to the tracking server.

9. The system of claim 5, wherein calculating a hash value that represents two or more participants in the interaction includes:
sorting user identifiers of two or more participants in the interaction;
combining the sorted user identifiers; and
calculating the hash value of the combined sorted user identifiers.

10. A method for efficiently counting unique user interactions within an application, the method comprising:
receiving an event notification indicating two or more users engaging in an interaction using the application;
calculating a hash value that represents the two or more users engaging in the interaction;
determining whether a previous interaction is represented by a matching hash value;
in response to determining that no previous interaction was represented by a matching hash value:
storing the hash value as a unique interaction; and
incrementing a unique interaction count for each of the two or more users; and
in response to determining that at least one previous interaction was represented by a matching hash value:
storing the hash value as a duplicate interaction.

11. The method of claim 10, wherein calculating the hash value includes:
sorting user identifiers of the two or more users engaging in the interaction;
combining the sorted user identifiers; and
calculating the hash value of the combined sorted user identifiers.

12. The method of claim 10, wherein receiving an event notification includes receiving an in-app event notification from the application executing on a client computing device.

13. The method of claim 10, wherein receiving an event notification includes receiving a postback event notification from a third-party server.

14. The method of claim 10, wherein determining whether a previous interaction is represented by a matching hash value includes performing a conditional put of the hash value in a data store.

15. The method of claim 14, wherein a successful conditional put indicates the hash value is unique, and wherein a failed conditional put indicates a matching hash value has previously been stored in the data store.
